(19) United States
(12) Patent Application Publication
(10) Pub. No.: US 2026/0292723 A1
(43) Pub. Date: Sep. 24, 2026

(54) MULTIPLE TIMING CONFIGURATIONS FOR SIGNALS

(71) Applicant: QUALCOMM Incorporated, San Diego, CA (US)

(72) Inventors: Aria HASANZADEZONUZY, Chatham, NJ (US); Navid ABEDINI, Basking Ridge, NJ (US); Jianghong LUO, Skillman, NJ (US); Yan ZHOU, San Diego, CA (US)

(21) Appl. No.: 19/083,158

(22) Filed: Mar. 18, 2025

(51) Int. Cl. H04W 56/00; H04L 5/00; H04W 16/28; H04W 52/36; H04W 74/0833

(52) U.S. Cl. CPC H04W 56/0015; H04L 5/0051; H04W 16/28; H04W 52/36; H04W 74/0833

(57) ABSTRACT

Various aspects of the present disclosure generally relate to wireless communication. In some aspects, a user equipment (UE) may receive a first timing configuration (TC) for a first type of signal and a second TC for a second type of signal. The UE may determine a first timing value for the first TC and a second timing value for the second TC, where the first timing value and the second timing value are coordinated in association with limiting a wake time of the UE. The UE may monitor for the first type of signal according to the first timing value and for the second type of signal according to the second timing value. Numerous other aspects are described.

Aspects of the present disclosure generally relate to wireless communication and specifically relate to techniques, apparatuses, and methods associated with timing configurations.

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication at a user equipment (UE). The method may include receiving a first timing configuration (TC) for a first type of signal and a second TC for a second type of signal. The method may include determining a first timing value for the first TC and a second timing value for the second TC, where the first timing value and the second timing value are coordinated in association with limiting a wake time of the UE. The method may include monitoring for the first type of signal according to the first timing value and for the second type of signal according to the second timing value.

Some aspects described herein relate to a method of wireless communication at a network entity. The method may include providing a first TC for a first type of signal and a second TC for a second type of signal, where a first timing value for the first TC and a second timing value for the second TC are coordinated in association with limiting a wake time of a UE. The method may include providing the first type of signal according to the first timing value and the second type of signal according to the second timing value.

Some aspects described herein relate to a method of wireless communication at a UE. The method may include receiving an indication that multiple random access channel occasions (ROs) are to be grouped consecutively. The method may include transmitting one or more uplink messages in the multiple ROs.

Some aspects described herein relate to a method of wireless communication at a network entity. The method may include providing an indication that multiple ROs are to be grouped consecutively. The method may include receiving uplink messages in the multiple ROs.

Some aspects described herein relate to a UE for wireless communication. The UE may include a processing system. The processing system may include one or more processors and one or more code-storing memories coupled with the one or more processors. The processing system may be configured to cause the UE to receive a first TC for a first type of signal and a second TC for a second type of signal. The processing system may be configured to cause the UE to determine a first timing value for the first TC and a second timing value for the second TC, where the first timing value and the second timing value are coordinated in association with limiting a wake time of the UE. The processing system may be configured to cause the UE to monitor for the first type of signal according to the first timing value and for the second type of signal according to the second timing value.

Some aspects described herein relate to a network entity for wireless communication. The network entity may include a processing system. The processing system may include one or more processors and one or more code-storing memories coupled with the one or more processors. The processing system may be configured to cause the network entity to provide a first TC for a first type of signal and a second TC for a second type of signal, where a first timing value for the first TC and a second timing value for the second TC are coordinated in association with limiting a wake time of a user equipment. The processing system may be configured to cause the network entity to provide the first type of signal according to the first timing value and the second type of signal according to the second timing value.

Some aspects described herein relate to a UE for wireless communication. The UE may include a processing system. The processing system may include one or more processors and one or more code-storing memories coupled with the one or more processors. The processing system may be configured to cause the UE to receive an indication that multiple ROs are to be grouped consecutively. The processing system may be configured to cause the UE to transmit one or more uplink messages in the multiple ROs.

Some aspects described herein relate to a network entity for wireless communication. The network entity may include a processing system. The processing system may include one or more processors and one or more code-storing memories coupled with the one or more processors. The processing system may be configured to cause the network entity to provide an indication that multiple ROs are to be grouped consecutively. The processing system may be configured to cause the network entity to receive uplink messages in the multiple ROs.

Some aspects described herein relate to an apparatus for wireless communication at a UE. The UE may include one or more memories and one or more processors coupled with the one or more memories and configured to cause the UE to receive a first TC for a first type of signal and a second TC for a second type of signal. The one or more processors may be configured to cause the UE to determine a first timing value for the first TC and a second timing value for the second TC, where the first timing value and the second timing value are coordinated in association with limiting a wake time of the UE. The one or more processors may be configured to cause the UE to monitor for the first type of signal according to the first timing value and for the second type of signal according to the second timing value.

Some aspects described herein relate to an apparatus for wireless communication at a network entity. The network entity may include one or more memories and one or more processors coupled with the one or more memories and configured to cause the network entity to provide a first TC for a first type of signal and a second TC for a second type of signal, where a first timing value for the first TC and a second timing value for the second TC are coordinated in association with limiting a wake time of a user equipment. The one or more processors may be configured to cause the network entity to provide the first type of signal according to the first timing value and the second type of signal according to the second timing value.

Some aspects described herein relate to an apparatus for wireless communication at a UE. The UE may include one or more memories and one or more processors coupled with the one or more memories and configured to cause the UE to receive an indication that multiple ROs are to be grouped consecutively. The one or more processors may be configured to cause the UE to transmit one or more uplink messages in the multiple ROs.

Some aspects described herein relate to an apparatus for wireless communication at a network entity. The network entity may include one or more memories and one or more processors coupled with the one or more memories and configured to cause the network entity to provide an indication that multiple ROs are to be grouped consecutively. The one or more processors may be configured to cause the network entity to receive uplink messages in the multiple ROs.

Some aspects described herein relate to a non-transitory computer-readable medium that stores a set of instructions for wireless communication by a UE. The set of instructions, when executed by one or more processors of the UE, may cause the UE to receive a first TC for a first type of signal and a second TC for a second type of signal. The set of instructions, when executed by one or more processors of the UE, may cause the UE to determine a first timing value for the first TC and a second timing value for the second TC, where the first timing value and the second timing value are coordinated in association with limiting a wake time of the UE. The set of instructions, when executed by one or more processors of the UE, may cause the UE to monitor for the first type of signal according to the first timing value and for the second type of signal according to the second timing value.

Some aspects described herein relate to a non-transitory computer-readable medium that stores a set of instructions for wireless communication by a network entity. The set of instructions, when executed by one or more processors of the network entity, may cause the network entity to provide a first TC for a first type of signal and a second TC for a second type of signal, where a first timing value for the first TC and a second timing value for the second TC are coordinated in association with limiting a wake time of a user equipment. The set of instructions, when executed by one or more processors of the network entity, may cause the network entity to provide the first type of signal according to the first timing value and the second type of signal according to the second timing value.

Some aspects described herein relate to a non-transitory computer-readable medium that stores a set of instructions for wireless communication by an UE. The set of instructions, when executed by one or more processors of the UE, may cause the UE to receive an indication that multiple ROs are to be grouped consecutively. The set of instructions, when executed by one or more processors of the UE, may cause the UE to transmit one or more uplink messages in the multiple ROs.

Some aspects described herein relate to a non-transitory computer-readable medium that stores a set of instructions for wireless communication by a network entity. The set of instructions, when executed by one or more processors of the network entity, may cause the network entity to provide an indication that multiple ROs are to be grouped consecutively. The set of instructions, when executed by one or more processors of the network entity, may cause the network entity to receive uplink messages in the multiple ROs.

Some aspects described herein relate to an apparatus for wireless communication. The apparatus may include means for receiving a first TC for a first type of signal and a second TC for a second type of signal. The apparatus may include means for determining a first timing value for the first TC and a second timing value for the second TC, where the first timing value and the second timing value are coordinated in association with limiting a wake time of the UE. The apparatus may include means for monitoring for the first type of signal according to the first timing value and for the second type of signal according to the second timing value.

Some aspects described herein relate to an apparatus for wireless communication. The apparatus may include means for providing a first TC for a first type of signal and a second TC for a second type of signal, where a first timing value for the first TC and a second timing value for the second TC are coordinated in association with limiting a wake time of a user equipment. The apparatus may include means for providing the first type of signal according to the first timing value and the second type of signal according to the second timing value.

Some aspects described herein relate to an apparatus for wireless communication. The apparatus may include means for receiving an indication that multiple ROs are to be grouped consecutively. The apparatus may include means for transmitting one or more uplink messages in the multiple ROs.

Some aspects described herein relate to an apparatus for wireless communication. The apparatus may include means for providing an indication that multiple ROs are to be grouped consecutively. The apparatus may include means for receiving uplink messages in the multiple ROs.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIGS. 3A-3B are diagrams illustrating an example of physical channels and reference signals in a wireless network.

FIG. 4 is a diagram illustrating an example of signal periods.

FIG. 5 is a diagram illustrating an example associated with coordinated timing configurations (TCs).

FIG. 6 is a diagram illustrating an example of timing values.

FIG. 7 is a diagram illustrating an example of a timing value.

FIG. 8 is a diagram illustrating an example of coordinated TCs.

FIGS. 9A and 9B are diagrams illustrating an examples of random access channel occasion (RO) patterns.

FIG. 10 is a diagram illustrating an example of using grouped ROs.

FIG. 11 is a diagram illustrating an example process performed, for example, at a user equipment (UE) or an apparatus of a UE.

FIG. 12 is a diagram illustrating an example process performed, for example, at a network entity or an apparatus of a network entity.

FIG. 13 is a diagram illustrating an example process performed, for example, at a UE or an apparatus of a UE.

FIG. 14 is a diagram illustrating an example process performed, for example, at a network entity or an apparatus of a network entity.

FIG. 15 is a diagram of an example apparatus for wireless communication.

FIG. 16 is a diagram illustrating an example of a hardware implementation for an apparatus employing a processing system.

FIG. 17 is a diagram illustrating an example of an implementation of code and circuitry for an apparatus.

FIG. 18 is a diagram of an example apparatus for wireless communication.

FIG. 19 is a diagram illustrating an example of a hardware implementation for an apparatus employing a processing system.

FIG. 20 is a diagram illustrating an example of an implementation of code and circuitry for an apparatus.

### DETAILED DESCRIPTION

In an example, a user equipment (UE) may be expected to use resources efficiently. The UE may use a discovery reference signal (DRS) that enables the initial discovery and synchronization of devices within a wireless network. The DRS enables devices to discover cells in the network. The UE may receive a master information block (MIB) that enables the UE to synchronize with the network and perform the initial access procedure. The MIB provides the UE with the basic information the UE may need to decode and communicate with the network. However, there is a potential shift in how DRSs and MIBs are delivered and processed. New signaling designs may be adopted that, while beneficial for network power savings, may inadvertently increase power consumption for UEs due to the lack of clarity on when and which signals the UEs are expected to measure.

In the context of cell (re)selection, when a UE is camped on a cell, the UE may begin to search or measure neighboring cells. If selection conditions are met, the UE may perform cell reselection and choose another cell to camp on. However, with different periodicities for DRS and a physical broadcast channel (PBCH), there may be an inherent inefficiency. For example, if the UE performs neighbor cell search/measurement during periods with a full synchronization signal block (SSB)/PBCH, the UEs could incur higher power consumption. Decoding a full SSB/PBCH consumes processing resources and power is consumed to stay awake to process the full SSB/PBCH. If a UE has a timing configuration (TC) for a DRS but lacks knowledge of a period of the full SSB/PBCH, the UEs may consume even more power. For example, the UE may experience frequent DRS and infrequent SSB/PBCH. This may cause the UE to stay awake longer than necessary to process the SSB/PBCH, which consumes power.

Various aspects relate generally to enhancing UE power efficiency in wireless communication systems. For example, some aspects involve providing multiple TCs for coordinating multiple signal types and other aspects involve grouping random access channel (RACH) occasions (ROs) together.

A TC for a signal type may indicate time resources for transmitting and receiving the signal type. For example, a TC may indicate a time-division structure based on frames, subframes, and slots. Additionally, or alternatively, a TC may indicate a frame duration and slots in a frame. In some aspects involving multiple TCs, a network entity may provide (e.g., transmit, or cause to transmit, initiate transmission) multiple TCs for multiple signal types to a UE, such as a first TC for a reference signal (e.g., DRS) and a second TC for another reference signal or system information (e.g., an SSB, a PBCH message, or a system information block (SIB)). The UE may determine timing values (e.g., periods, time durations) for the TCs of the multiple signal types. The signal types may be coordinated to limit the wake time of the UE (e.g., to reduce the wake time or to maintain the wake time to be less than a wake time threshold), thereby conserving battery resources. For example, the UE may determine a first period for DRS from a TC for DRS and a second period for SSB/PBCH from a TC for SSB/PBCH. The UE may wake up to monitor for, receive, and process the signals according to time occasions of the first period and the second period. In this manner, the UE may monitor for the DRS and SSB/PBCH/SIB according to their respective periods. In some aspects, the coordination of signal types may include selecting the second timing value of the second signal type to be periodic so as to not leave gaps between occasions of the first timing value of the first signal type and occasions of the second timing value of the second signal type.

In some aspects, coordination may include selecting the second timing value to overlap in part with the first timing value and using a rule to select which signal is to be used for an overlapping occasion. For example, if the timing values for DRS and SSB/PBCH/SIB overlap, the UE may prioritize reception of one signal over the other based on signal priority rules, which may be pre-established. A priority rule may include, for example, the SSB being transmitted instead of a DRS. This approach helps to streamline the monitoring for the signals and further reduce power consumption by the UE during periods of overlap.

By coordinating the timing for DRS and SSB/PBCH/SIB, the described techniques can optimize the UE's wake-up schedule, thereby reducing power consumption during idle or inactive periods. Additionally, or alternatively, the power savings may occur without compromising the UE's ability to perform essential functions such as cell discovery and measurement for cell (re)selection. This optimization may conserve processing resources and battery life of the UE.

In some aspects, the UE may adjust its wake-up schedule based on the coordinated timing of the signals, further limiting power consumption during periods of inactivity. By prioritizing which signal to receive during overlapping time occasions of different signal types, the UE conserves energy by avoiding waking up for unnecessary signal monitoring, thereby enhancing power efficiency.

Additionally, or alternatively, UEs may receive indications regarding a permissibility of DRS-based measurements for cell reselection and the potential combination with SSB measurements. This guidance allows UEs to perform more accurate and energy-efficient cell reselection procedures. Moreover, a network entity may inform the UEs about the relative transmission power levels of DRS and SSB, enabling the UEs to combine measurements accurately if permitted. This information affords UEs the facility to make informed decisions about signal quality and strength, leading to more reliable and power-efficient operations.

In some aspects, a UE may decode a one-to-one mapping between cell IDs and signal IDs, and thus the UE can avoid confusion about which cell the UE is measuring, thereby enabling more precise and power-efficient cell tracking and reselection processes. In this way, the proposed solutions conserve processing resources, memory resources, and network resources, and reduce random access channel (RACH) latency during cell reselection and connection stages. The techniques support network entities in conserving power and simplifying signaling without incurring excessive power consumption or network coordination overhead.

In some scenarios associated with a time division Duplexing (TDD) configuration, a UE may transmit a RACH message in an uplink slot, or RO. However, there may be a pattern of one RO (uplink slot) for multiple (e.g., five) downlink slots. While this pattern achieves a balance in downlink/uplink load, the spaces between ROs may prevent the network from entering deeper levels of sleep, thus preventing energy savings that could be realized from more efficient RACH occasion placement. In some aspects, the UE may group the ROs, such that they are consecutive in time or back-to-back (e.g., in adjacent time slots or occasions). For example, there may be four ROs back-to-back and then a longer sleep time. A longer sleep time allows for a deeper sleep and more power conservation.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

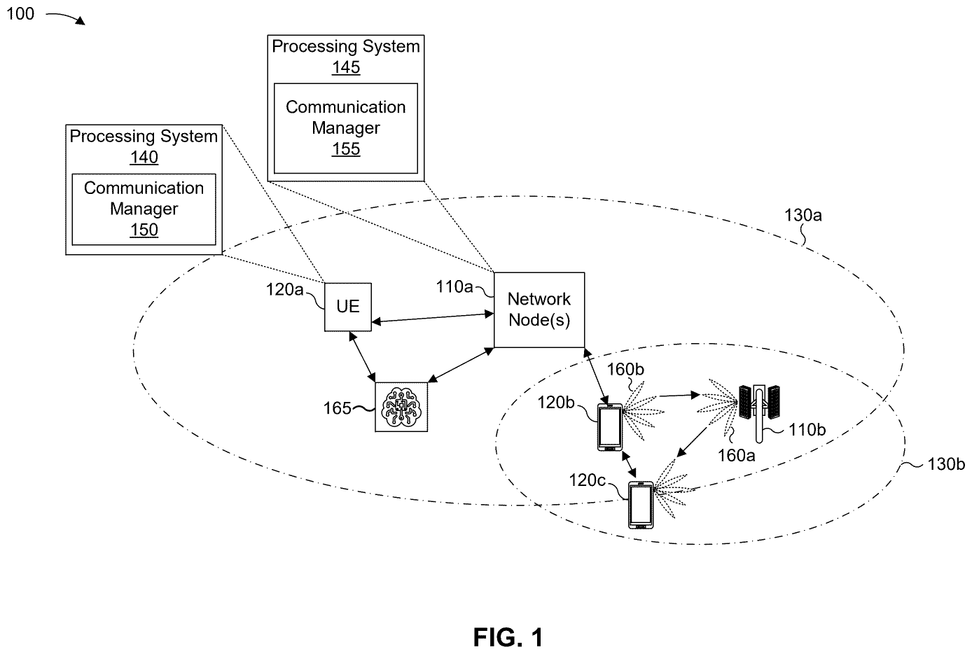

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SSB (for example, that includes a PSS, an SSS, and a PBCH), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NCJT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a UE (e.g., a UE 120) may include a communication manager 150. As described in more detail elsewhere herein, the communication manager 150 may receive a first TC for a first type of signal and a second TC for a second type of signal; determine a first timing value for the first TC and a second timing value for the second TC, where the first timing value and the second timing value are coordinated in association with limiting a wake time of the UE; and monitor for the first type of signal according to the first timing value and for the second type of signal according to the second timing value.

In some aspects, the communication manager 150 may receive an indication that multiple ROs are to be grouped consecutively; and transmit one or more uplink messages in the multiple ROs. Additionally, or alternatively, the communication manager 150 may perform one or more other operations described herein.

In some aspects, a network entity (e.g., a network node 110) may include a communication manager 155. As described in more detail elsewhere herein, the communication manager 155 may provide a first TC for a first type of signal and a second TC for a second type of signal, where a first timing value for the first TC and a second timing value for the second TC are coordinated in association with limiting a wake time of a user equipment; and provide the first type of signal according to the first timing value and the second type of signal according to the second timing value.

In some aspects, the communication manager 155 may provide an indication that multiple ROs are to be grouped consecutively; and receive uplink messages in the multiple ROs. Additionally, or alternatively, the communication manager 155 may perform one or more other operations described herein.

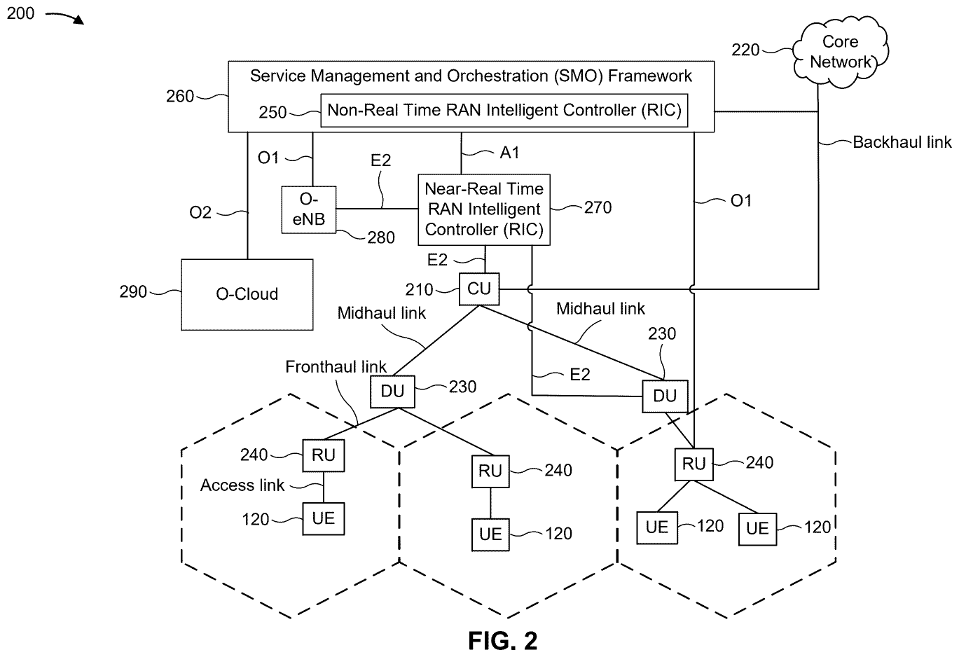

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

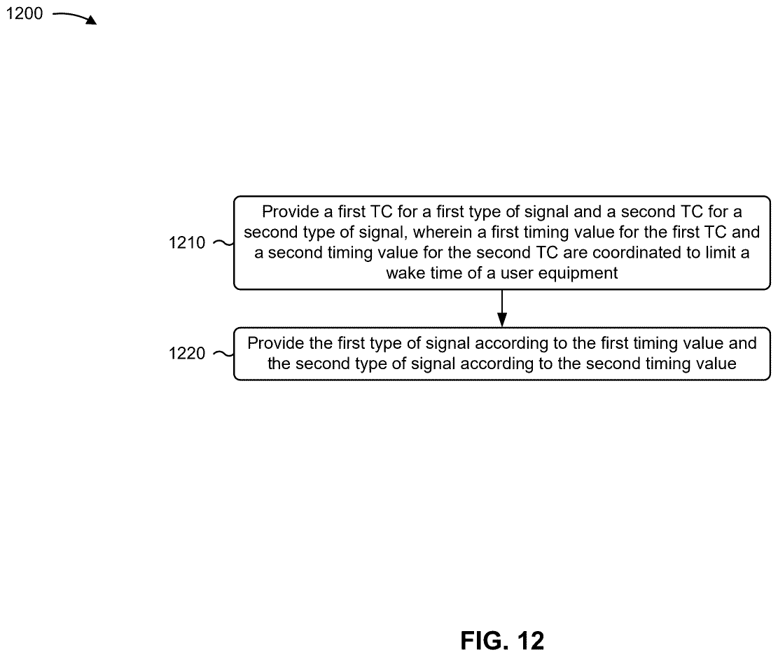

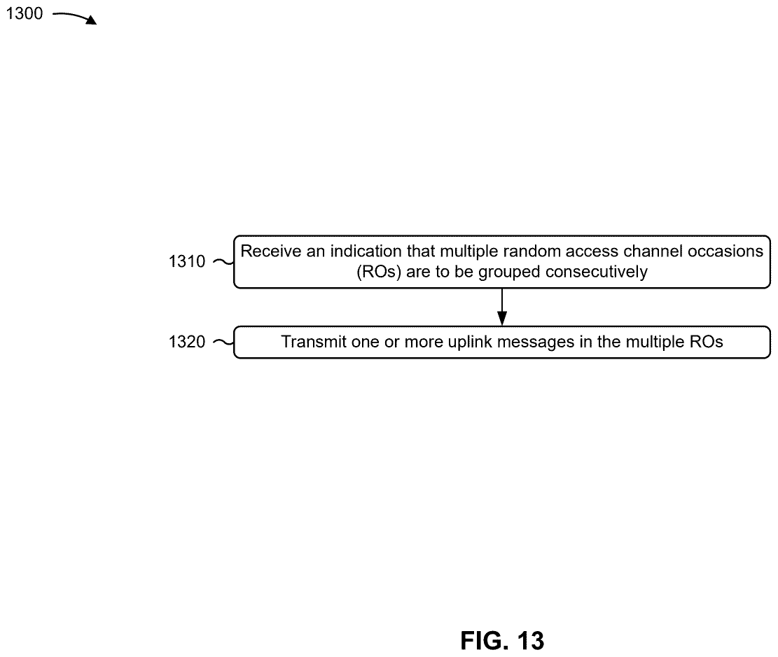

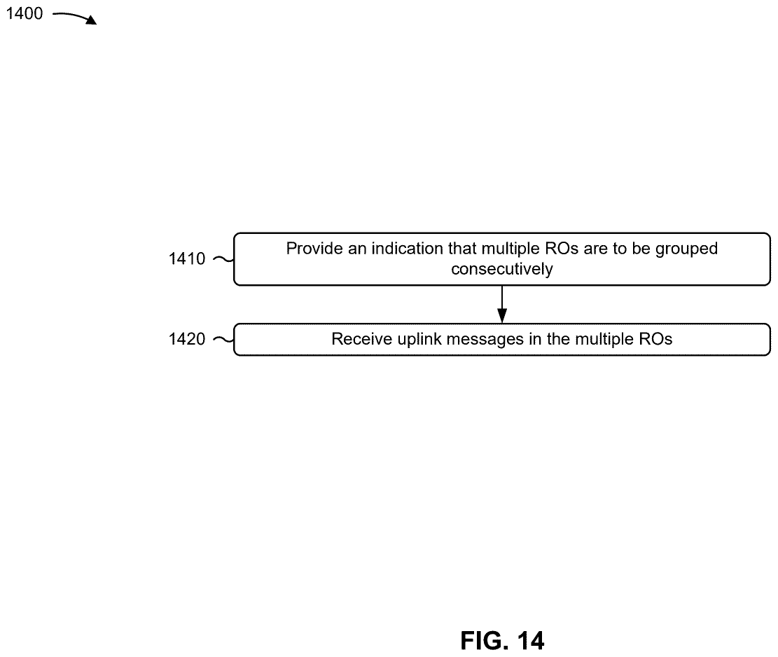

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with coordinated TCs, as described in more detail elsewhere herein. For example, the processing system 145 of the network node 110, the processing system 140 of the UE 120, the CU 210, the DU 230, or the RU 240 may perform or direct operations of, for example, process 1100 of FIG. 1, process 1200 of FIG. 12, process 1300 of FIG. 13, process 1400 of FIG. 14, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 1, process 1200 of FIG. 12, process 1300 of FIG. 13, process 1400 of FIG. 14, or other processes as described herein. In some examples, executing instructions may include running the instructions, converting the instructions, compiling the instructions, or interpreting the instructions, among other examples.

In some aspects, a UE (e.g., a UE 120) includes means for receiving a first TC for a first type of signal and a second TC for a second type of signal; means for determining a first timing value for the first TC and a second timing value for the second TC, where the first timing value and the second timing value are coordinated in association with limiting a wake time of the UE; or means for monitoring for the first type of signal according to the first timing value and for the second type of signal according to the second timing value.

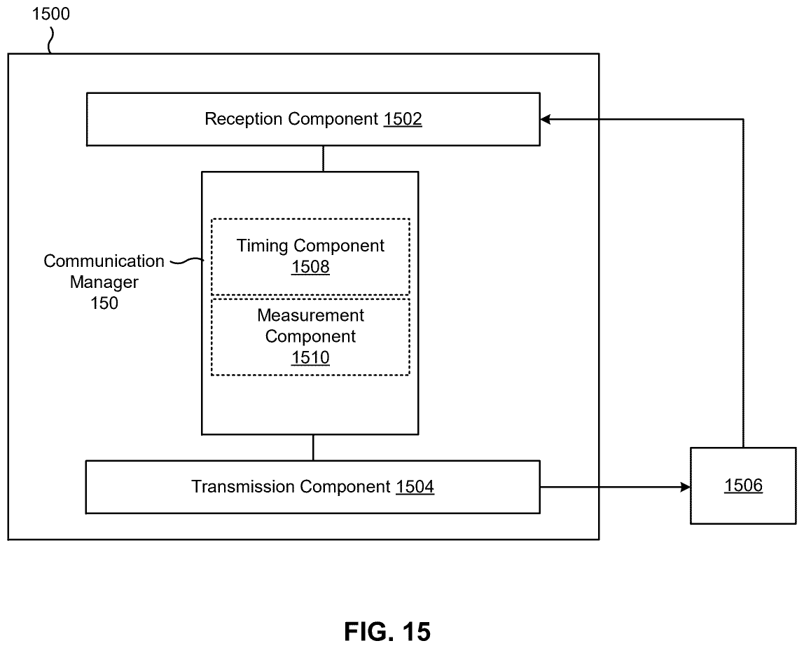

In some aspects, the UE includes means for receiving an indication that multiple ROs are to be grouped consecutively; or means for transmitting one or more uplink messages in the multiple ROs. The means for the UE to perform operations described herein may include, for example, one or more of communication manager 150, processing system 140, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

In some aspects, a network entity (e.g., a network node 110) includes means for providing a first TC for a first type of signal and a second TC for a second type of signal, wherein a first timing value for the first TC and a second timing value for the second TC are coordinated in association with limiting a wake time of a user equipment; or means for providing the first type of signal according to the first timing value and the second type of signal according to the second timing value

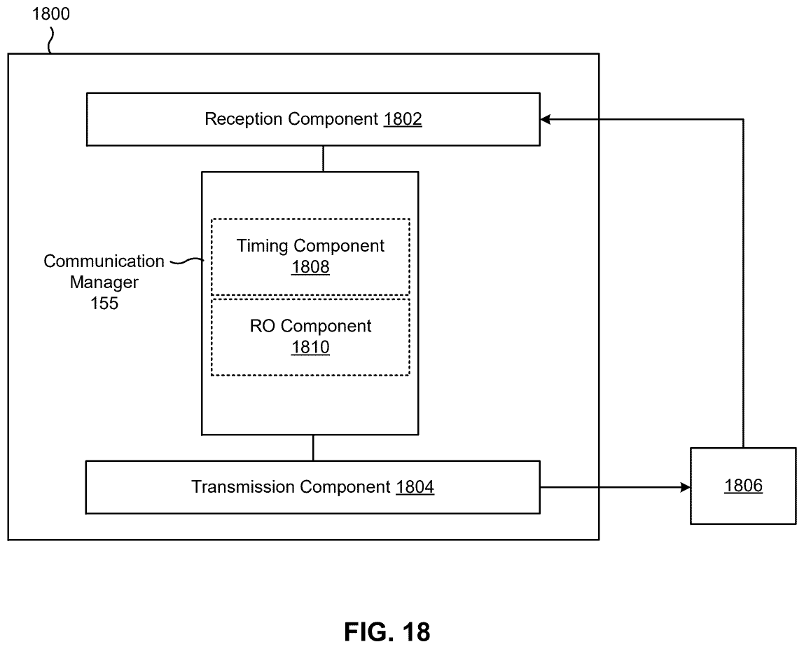

In some aspects, the network entity includes means for providing an indication that multiple ROs are to be grouped consecutively; or means for receiving uplink messages in the multiple ROs. In some aspects, the means for the network entity to perform operations described herein may include, for example, one or more of communication manager 155, processing system 145, a radio, one or more RF chains, one or more transceivers, one or more antennas, one or more modems, a reception component (for example, reception component 1802 depicted and described in connection with FIG. 18), or a transmission component (for example, transmission component 1804 depicted and described in connection with FIG. 18), among other examples.

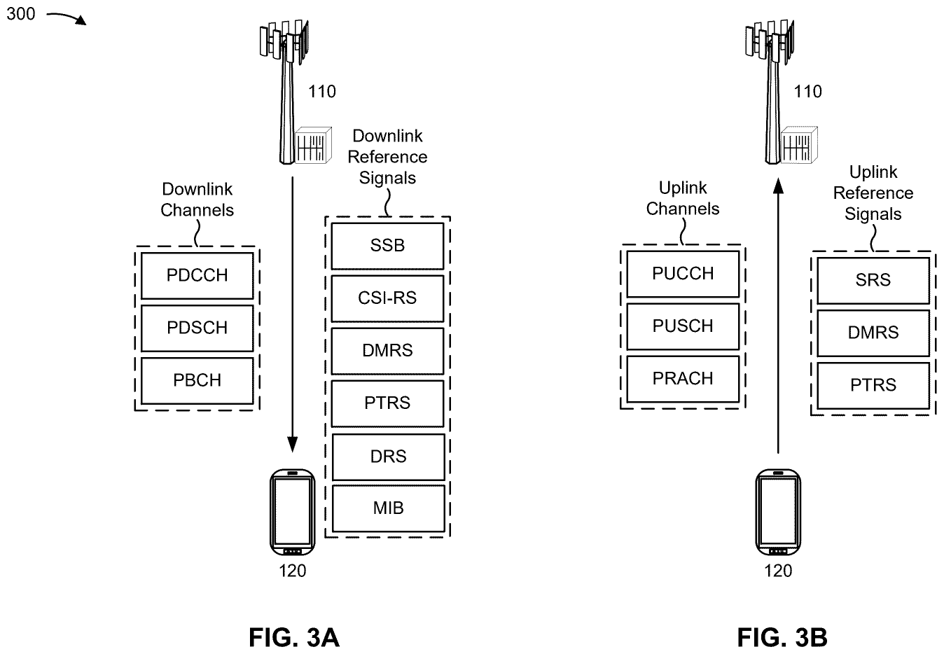

FIGS. 3A-3B are diagrams illustrating an example 300 of physical channels and reference signals in a wireless network. As shown in FIG. 3A, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, PDSCH that carries downlink data, or a PBCH that carries system information, among other examples. In some aspects, PDSCH communications may be scheduled by PDCCH communications. As further shown, an uplink channel may include a PUCCH that carries UCI, a PUSCH that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH or the PUSCH.

As further shown, a downlink reference signal may include an SSB, a CSI-RS, a DMRS, a positioning reference signal (PRS), or a phase tracking reference signal (PTRS), among other examples. As also shown, an uplink reference signal may include a sounding reference signal (SRS), a DMRS, a PTRS, a DRS, or a MIB among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a PMI, a CRI, a layer indicator (LI), a rank indicator (RI), or an RSRP, among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A DRS enables the initial discovery and synchronization of devices with the network. The DRS enables devices to discover cells in the network. UEs use the DRS to search for and identify nearby cells. The DRS helps the UE synchronize with the cell's timing and frequency. A DRS is part of the process that allows a UE to perform random access to the network, especially during the initial connection phase.

An MIB enables a UE to synchronize with the network and perform the initial access procedure. The MIB provides the UE with the basic information required to decode and communicate with the network. The MIB helps the UE to synchronize with the network, identify the cell to which the UE is connected, and decode higher-layer signaling (e.g., SIBs) that provides more detailed information about the network. The MIB may be broadcast in the PBCH.

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

As shown in FIG. 3B, an SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 3A and FIG. 3B are provided as an example. Other examples may differ from what is described with regard to FIG. 3A and FIG. 3B.

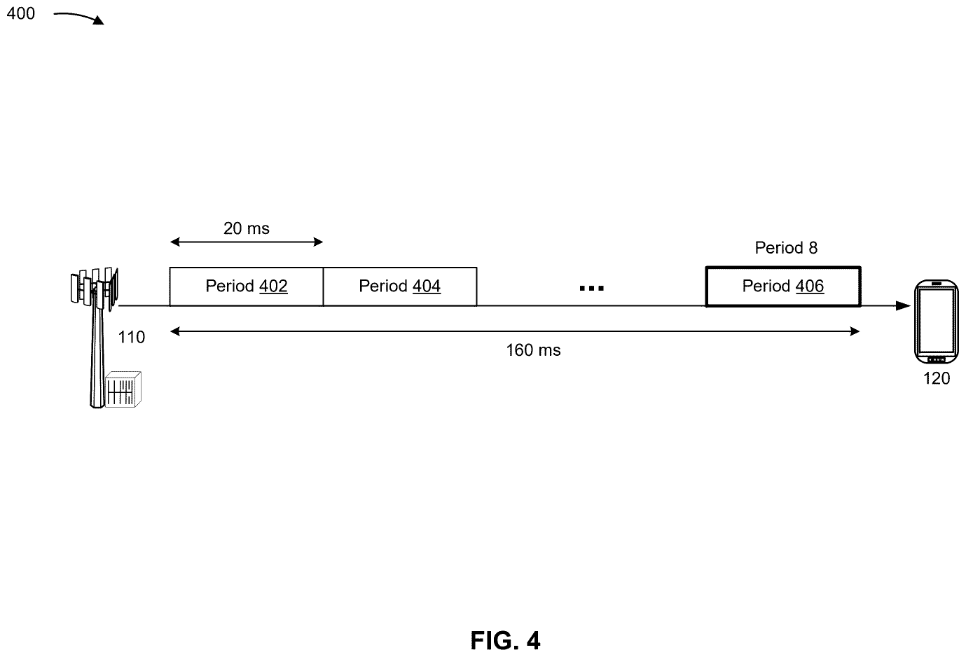

FIG. 4 is a diagram illustrating an example 400 of signal periods.

Different signals can have a different frequency of transmission. For example, a DRS may be transmitted more frequently than an MIB or a full SSB. Example 400 shows that in a first seven periods (period 402, period 404, . . . ), the network node 110 may transmit a DRS every 20 ms, while the SSB and/or PBCH (and maybe other signals such as SIB1) would be transmitted every 160 ms, or every eighth period (period 406).

In an example with 5G, when a UE 120 is camping on a cell, the UE 120 may sometimes perform a neighboring cell search and measurement. If the cell reselection conditions are met for the UE 120, the UE 120 may perform cell reselection. The UE 120 may select another cell to camp on. The conditions are defined based on strength and/or quality (e.g., RSRP/RSRQ), associated signal strength or quality thresholds, and an amount of evaluation time, along with other configurable parameters like offsets. When the UE 120 is performing cell reselection, some criteria may be satisfied for some amount of time.

In an example with 6G and with DRS, when UEs are performing neighbor cell search/measurement, the UEs only need to detect and measure a DRS. When the UEs want to perform cell resection, the UEs acquire a full SSB (including a MIB) and system information (SI) of the targeted neighbor cell.

In 5G, SSB includes both signals for detection/measurement (PSS and SSS), and some SI (MIB in PBCH). When 5G UEs camp on a cell, the network entity 110 may indicate the TC of the SSB of the neighbor cells via an SSB measurement timing configuration (SMTC) framework. However, in 6G, these two signals (DRS and PBCH) are going to be transmitted according to different periods. If the camped cell only indicates the TC of one of the signals, the UEs would consume more energy. If UEs perform neighbor cell search/measurement in the period with the full SSB/PBCH, the UE could increase power consumption (e.g., by 6%). On the other hand, if UEs do not know which periods contain a full SSB/PBCH, the UEs would consume around 12% more power. That is, the UE 120 should wake up once for DRS, and once for PBCH/SIB1. As the industry advances toward 6G, there is a potential shift in how DRS and MIB are delivered and processed. This creates concerns regarding network energy conservation by adopting new signaling designs which, while beneficial for network power savings, may inadvertently increase power consumption for UEs due to the lack of clarity on when and which signals the UEs are expected to measure-be it DRS or MIB transmitted via the PBCH.

Another aspect of concern is the potential sporadic placement of ROs due to the TDD configuration in 5G, which typically leads to one uplink slot every five slots. While this pattern achieves a balance in downlink/uplink load, the pattern may prevent the network from entering deeper levels of sleep, thus preventing energy savings that could be realized from more efficient RACH occasion placement.

Moreover, the current 5G framework may not support the envisioned DRS designs for 6G that may not carry full or partial physical cell IDs (PCI), causing confusion for UEs as the UEs cannot ascertain which cell the UEs are measuring for potential reselection or reporting back to the network when connected.

Various aspects relate generally to enhancing UE power efficiency in wireless communication systems, particularly in upcoming 6G networks. Some aspects more specifically relate to a network entity providing (e.g., transmitting, or causing to transmit, initiating transmission) multiple TCs to a UE, such as a first TC for a DRS and a second TC for an SSB, a PBCH message, or a SIB. The UE may determine timing values (e.g., periods) for both TCs, which are coordinated to limit the wake time of the UE, thereby conserving battery resources. The UE may monitor for and receive the DRS and SSB/PBCH/SIB according to their respective timing values. By coordinating the timing for DRS and SSB/PBCH/SIB, the described techniques optimize the UE's wake-up schedule, thereby reducing power consumption during idle or inactive periods without compromising the UE's ability to perform essential functions such as cell discovery and measurement for cell (re)selection. This optimization may conserve processing resources and battery life of the UE.

As shown by FIG. 4, and reference number 400, a network node 110 and a UE 120 may communicate with one another. For example, the network node 110 may transmit different types of signals to the UE 120 at different periods. As shown, the network node 110 may transmit a DRS every 20 milliseconds during periods 402, 404, and others. Additionally, the network node 110 may transmit an SSB along with other signals such as a PBCH every 160 milliseconds during period 406.

In some aspects, transmitting the DRS more frequently than the SSB/PBCH provides continuous monitoring and quick response capability, while the less frequent transmission of SSB/PBCH reduces overall power consumption for the UE 120, as the UE 120 does not need to continuously monitor for these signals. For example, this approach allows the UE 120 to enter a deep sleep mode during periods without SSB/PBCH, thus conserving energy. Additionally, or alternatively, the network node 110 may transmit the DRS at varying intervals such as every 10 milliseconds or every 50 milliseconds to accommodate different network configurations or requirements. For instance, in a high-density network environment, a 10-millisecond interval may ensure quicker network discovery and synchronization, while a 50-millisecond interval may be utilized in a low-density network to conserve power.

Additionally, or alternatively, in addition to an SSB and a PBCH, the network node 110 may also transmit other types of signals such as a SIB or paging signals during period 406 or at different intervals to provide more comprehensive system information. For example, the SIB may include essential configuration parameters for the UE 120, while paging signals may notify the UE 120 of incoming communications.

Additionally, or alternatively, the network node 110 may transmit a different type of initial access signal, such as a PSS or an SSS, alongside or instead of the DRS or SSB to enhance initial network discovery and synchronization. The PSS and SSS may help the UE 120 in determining the cell identity and frame timing more accurately.

Additionally, or alternatively, the network node 110 may transmit the DRS and SSB with varying transmission power levels, and the UE 120 may adjust its reception parameters based on the indicated power offset between these signals to optimize measurement accuracy and power consumption. This allows the UE 120 to dynamically adapt to different signal strengths and maintain reliable communication.

Additionally, or alternatively, the network node 110 may transmit beam-specific DRS and SSB signals, with the UE 120 receiving indications of the beam patterns to improve measurement and synchronization accuracy under varying beamforming conditions. For instance, beam-specific signals can improve performance in environments with high multipath propagation.

Additionally, or alternatively, the network node 110 may provide multiple TCs for different types of signals, allowing the UE 120 to efficiently schedule its wake-up times and optimize power consumption further by prioritizing certain signals over others based on their importance. For example, a high-priority signal may be monitored more frequently than a low-priority signal.

Additionally, or alternatively, the network node 110 may transmit an indication of the periodicity and timing offsets for the DRS and SSB signals, allowing the UE 120 to pre-schedule its monitoring activities and reduce the need for continuous wakefulness. This pre-scheduling helps the UE 120 to manage its power resources better.

Additionally, or alternatively, the network node 110 may utilize a dynamic scheduling mechanism where the intervals for DRS and SSB transmissions can be adjusted in real-time based on network conditions and UE activity levels to further enhance power efficiency and communication reliability. For instance, during peak usage times, the intervals may be shortened to improve responsiveness, while during idle times, intervals may be extended to save power.

Additionally, or alternatively, the UE 120 may be configured to use machine learning algorithms to predict the transmission patterns of the DRS and SSB based on historical data, allowing for more intelligent power management and signal monitoring strategies. This predictive capability can help reduce unnecessary wake-ups and optimize power usage.

Additionally, or alternatively, the network node 110 may provide an indication of neighboring cell ROs to the UE 120, allowing the UE to prepare and transmit uplink messages more efficiently and reduce latency during cell reselection or initial access procedures. This can improve the UE's overall user experience by minimizing connection delays.

The network entity 110 and the UE 120 may utilize this periodic transmission of DRS and SSB to optimize power consumption and improve communication efficiency. The DRS may be used for initial network discovery and synchronization, while the SSB and PBCH may provide critical system information to the UE 120.

For example, the network node 110 may indicate two TCs, one for both DRS (with lower periodicity) and one for SSB/PBCH (with higher periodicity). Hence, UEs could save energy when the UEs are searching or performing measurements on neighboring cells (leveraging frequent DRS) or reselecting a neighboring cell (leveraging SSB/PBCH). There might be designs where the network entity does not transmit two types of signal in the same period. For example, the network node 110 may provide a DRS every 20 ms and a full SSB every 160 ms. But in the period where DRS and full SSB are supposed to be sent, the network node 110 does not send a DRS, only a full SSB. Then, the offset of the full SSB and DRS might be overlapping. In other examples, TCs may be provided for other types of signals.

As indicated above, FIG. 4 is provided as an example. Other examples may differ from what is described with regard to FIG. 4.

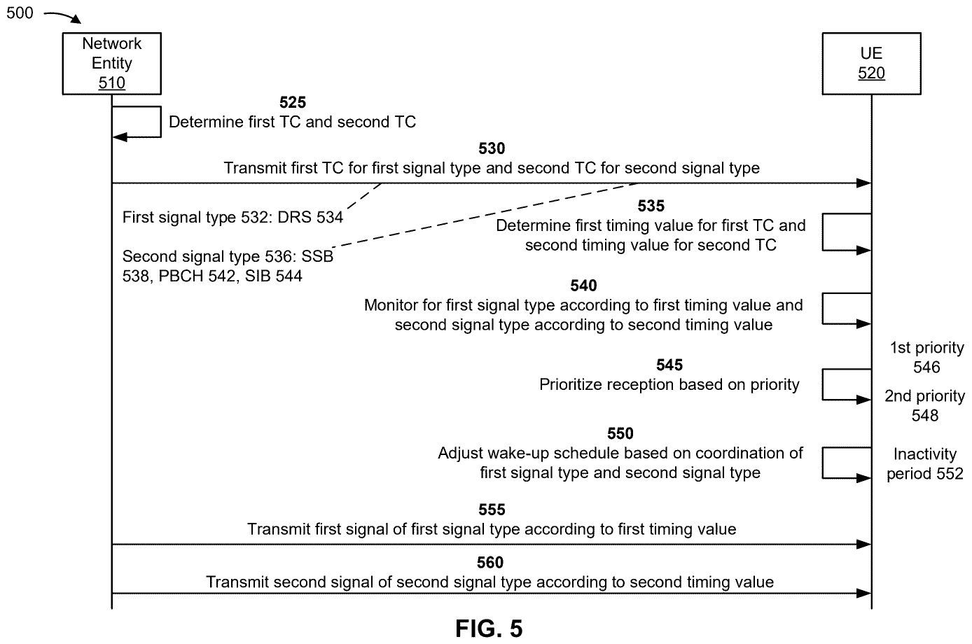

FIG. 5 is a diagram illustrating an example 500 associated with coordinated TCs. As shown in FIG. 5, a network entity 510 (e.g., network node 110) and a UE 520 (e.g., UE 120) may communicate with one another.

As shown by FIG. 5, and reference number 500, the network entity 510 and the UE 520 may communicate with one another. For example, the network entity 510 may determine a first TC for a first type of signal and a second TC for a second type of signal, as indicated by 525. As further shown, the network entity 510 may provide the first TC for the first type of signal and the second TC for the second type of signal, as indicated by 530. The UE 520 may receive the first TC and the second TC from the network entity 510.

The UE 520 may determine a first timing value for the first TC and a second timing value for the second TC, as indicated by 535. The first timing value and the second timing value may be coordinated to limit a wake time of the UE 520. For instance, the UE 520 may determine the first timing value and the second timing value based on the received TCs, optimizing its power consumption. The second timing value may overlap or not overlap with part of the first timing value.

The UE 520 may monitor for the first type of signal according to the first timing value and for the second type of signal according to the second timing value, as indicated by 540. For example, the first type of signal may be a DRS 534, and the second type of signal may be an SSB 538, a PBCH 542, or a SIB 544.

As indicated by 545, the UE 520 may prioritize reception of the first type of signal or the second type of signal based at least in part on a comparison of a priority of the first type of signal 546 and a priority of the second type of signal 548. For instance, the UE 520 may prioritize monitoring for the SSB 538 over the DRS 534 if the SSB has a higher priority. Additionally, or alternatively, the UE 520 may prioritize reception of the first type of signal or the second type of signal based on the priority of the first type of signal and the priority of the second type of signal. For example, if the PBCH 542 has a higher priority than the DRS 534, the UE may allocate more resources to ensure reliable reception of the PBCH.

The UE 520 may adjust its wake-up schedule based on the coordination of the first type of signal and the second type of signal to limit power consumption during periods of inactivity, as indicated by 550. For example, the UE 520 may enter a deep sleep mode during an inactivity period 552, waking up only for the coordinated reception times of the DRS 534 and the SSB 538. In some aspects, adjusting the wake-up schedule based on the coordination of the first type of signal and the second type of signal may include receiving an indication that multiple ROs are to be grouped consecutively and transmitting one or more uplink messages in the multiple ROs. For instance, the UE may adjust its wake-up schedule to align with the grouped ROs, optimizing uplink transmissions. Additionally, or alternatively, adjusting the wake-up schedule based on the coordination of the first type of signal and the second type of signal may include receiving an RO configuration that indicates an offset, a start symbol, an end symbol, a length of an RO, a periodicity of ROs, or a combination thereof. This configuration allows the UE to further refine its wake-up schedule based on the detailed RO parameters.

As indicated by 555, the network entity 510 may transmit the first signal of the first type (i.e., the DRS 534) according to the first timing value. Similarly, as indicated by 560, the network entity 510 may transmit the second signal of the second type (i.e., the SSB 538, PBCH 542, or SIB 544) according to the second timing value. In some aspects, transmitting the second signal of the second type according to the second timing value may include transmitting an indication of a power offset between a transmission power for the first type of signal and a transmission power for the second type of signal. For example, the network entity may adjust the transmission power based on the indicated power offset to balance the signal strengths. Additionally, or alternatively, transmitting the second signal of the second type according to the second timing value may include transmitting an indication of a first beam pattern for the first TC and a second beam pattern for the second TC. This allows the network entity to optimize beamforming for the respective signals, ensuring efficient signal delivery.

As indicated above, FIG. 5 is provided as an example. Other examples may differ from what is described with respect to FIG. 5.

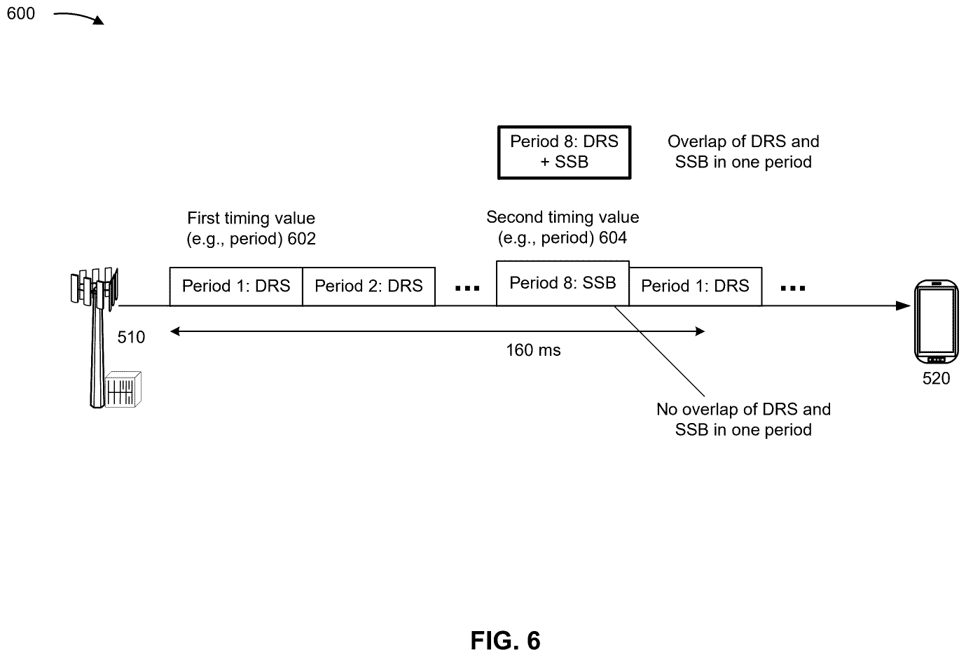

FIG. 6 is a diagram illustrating an example 600 of timing values.

Example 600 shows a first timing value 602 (e.g., period) for a DRS and a second timing value 604 (e.g., period) for an SSB. If there is not overlap between the DRS and the SSB, the SSB may be transmitted. If there is overlap, both the DRS and the SSB may be transmitted.

As indicated above, FIG. 6 is provided as an example. Other examples may differ from what is described with respect to FIG. 6.

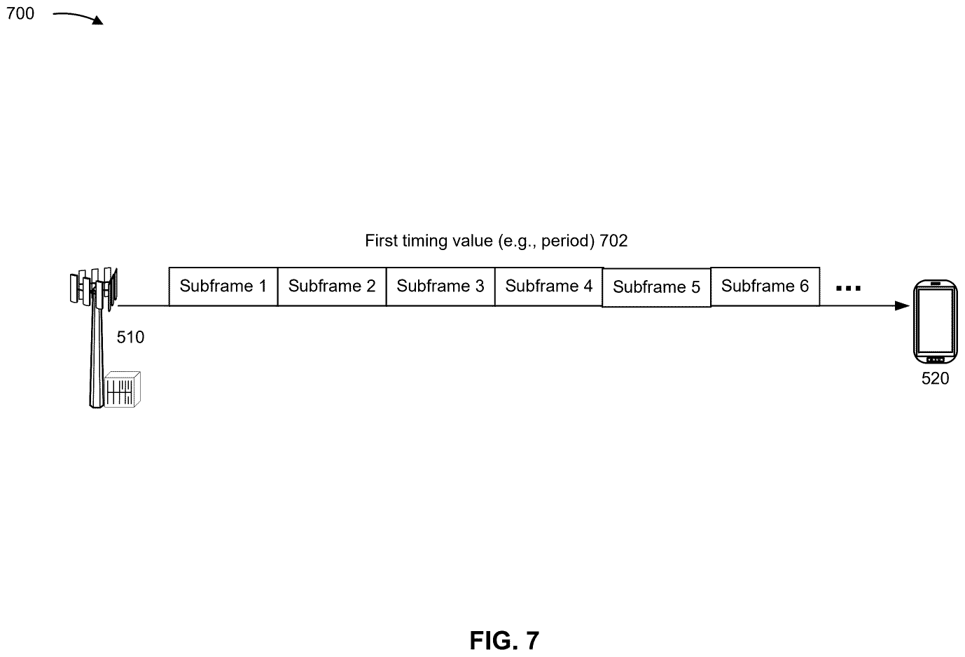

FIG. 7 is a diagram illustrating an example 700 of a timing value.

Example 700 shows an example of a first timing value 702, such as a period or a time duration, being greater than 5 subframes. The period is at least 6 subframes.

As indicated above, FIG. 7 is provided as an example. Other examples may differ from what is described with regard to FIG. 7.

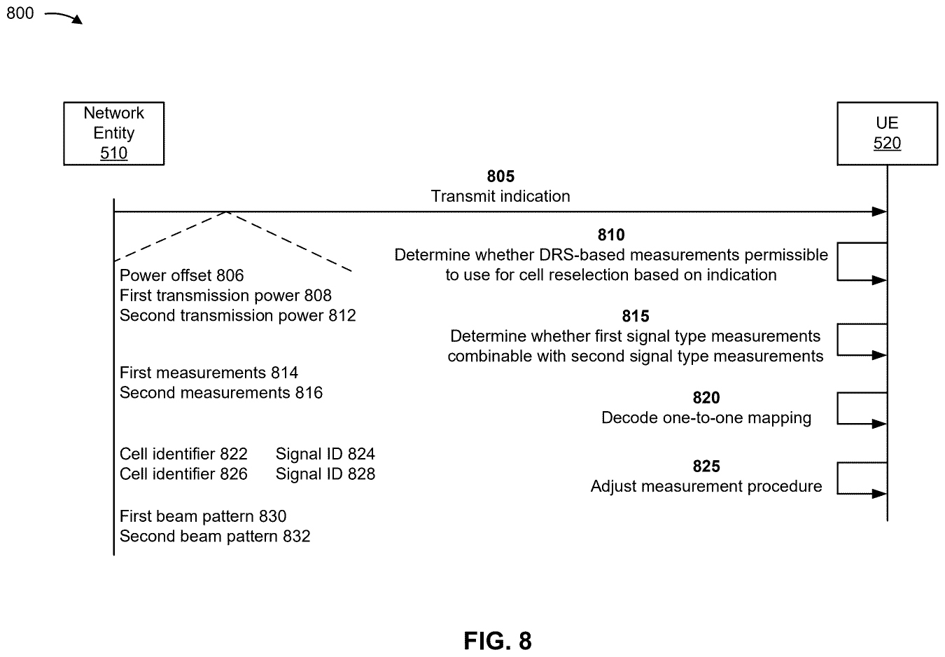

FIG. 8 is a diagram illustrating an example 800 of coordinated TCs. Example 800 shows further operations with respect to example 500.

As shown by 805, the network entity 510 may provide an indication to the UE 520. The indication may relate to various configurations such as power offsets, measurement combinations, and beam patterns.

As further shown, the indication may include a power offset 806, which is a difference between a first transmission power 808 and a second transmission power 812. This allows the UE 520 to adjust its reception parameters based on the indicated power levels. For example, the UE 520 may utilize the power offset 806 to understand the differences in transmission power between the first and second types of signals, ensuring accurate measurements. Additionally, or alternatively, the network entity 510 may send a power adjustment command to the UE 520. This command may instruct the UE 520 to adjust its power settings based on the received power offset 806, ensuring optimal signal reception and reduced power consumption. For example, the power adjustment command may instruct the UE 520 to increase its reception sensitivity for low-power signals.

As shown by 810, the network entity 510 may determine whether DRS-based measurements are permissible for cell reselection based on the indication. This helps the UE 520 decide whether it can use DRS-based measurements for cell reselection, optimizing its reselection process. Additionally, or alternatively, the network entity 510 may indicate measurement permissibility to the UE 520, specifying whether DRS-based measurements are allowed for specific scenarios such as cell reselection or initial access, thereby guiding the UE 520's measurement strategy. For example, measurement permissibility may allow DRS-based measurements 810 for high-priority cell reselection scenarios.

Additionally, the network entity 510 may determine whether first signal type measurements 814 are combinable with second signal type measurements 816 based at least in part on the indication. This allows the UE 520 to combine measurements from different signal types, improving measurement accuracy and efficiency. Additionally, or alternatively, the network entity 510 may transmit a combined measurement rule to the UE 520. This rule may specify whether the UE 520 can combine measurements from DRS and SSBs to enhance measurement accuracy. For instance, the combined measurement rule may enable the UE 520 to aggregate measurements from both signal types to improve signal detection and quality.

As shown by 820, the UE 520 may decode a one-to-one mapping between cell identifiers 822 and 826 and signal IDs 824 and 828. This ensures that the UE 520 accurately identifies cells based on received signals, facilitating better network management and cell reselection. Additionally, or alternatively, the UE 520 may receive a mapping configuration from the network entity 510, which details the relationship between DRS IDs and cell IDs. This mapping configuration helps the UE 520 to identify and measure the correct cells during reselection processes. For example, the mapping configuration may provide a detailed map of cell identifiers and corresponding signal IDs to ensure accurate cell selection by the UE 520.

Furthermore, the indication may provide information regarding a first beam pattern 830 and a second beam pattern 832. As shown by 825, the UE 520 may adjust its measurement procedure based on these beam patterns, enhancing its ability to synchronize and measure signals accurately. Additionally, or alternatively, the indication may provide a beam pattern configuration. This beam pattern configuration may include information on the number of beams and their respective directions for both the first type of signal and the second type of signal, aiding the UE 520 in accurate beamforming and signal reception. For instance, the beam pattern configuration may specify the beam angles and transmission powers for each beam, thus enhancing the UE 520's signal reception capabilities. Additionally, or alternatively, the UE 520 may utilize a synchronization procedure based on the first beam pattern 830 and second beam pattern 832 provided by the network entity 510. This synchronization procedure ensures that the UE 520 can accurately time its measurements and signal receptions according to the beam patterns. For example, the synchronization procedure may include steps for aligning the UE 520's reception timing with the beam transmission intervals.

As indicated above, FIG. 8 is provided as an example. Other examples may differ from what is described with regard to FIG. 8.

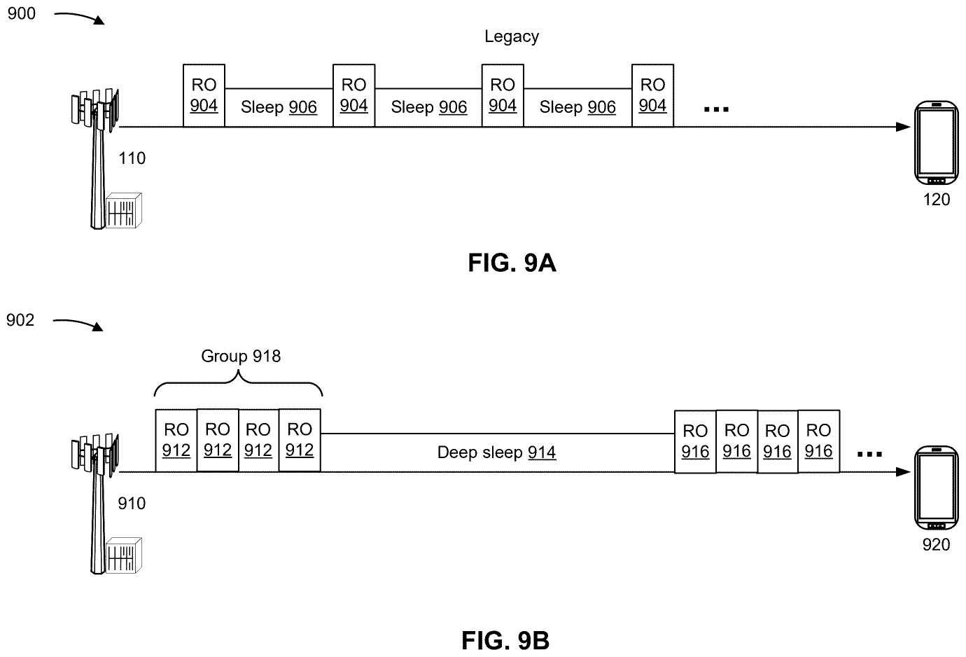

FIGS. 9A and 9B are diagrams illustrating an examples 900 and 902 of RO patterns.

As shown by FIG. 9A, and example 900, a network node 110 and a UE 120 may communicate with one another. For example, the network node 110 may transmit ROs 904 to the UE 120 at specific intervals. In between these intervals, the UE 120 may enter a sleep state 906 to conserve power. This pattern of ROs and sleep states is indicative of a legacy configuration where ROs are spaced apart, allowing the UE 120 to conserve power by entering intermittent sleep states.

As shown by FIG. 9B, and example 902, a network entity 910 and a UE 920 may communicate with each other using a more optimized approach. For instance, the network entity 910 may group multiple ROs 912 consecutively into a group 918. Following the group 918 of multiple consecutive ROs 912, the UE 920 may enter a deep sleep state 914 for an extended period, further conserving power as compared to the legacy configuration. Additionally, the network entity 910 may transmit additional ROs 916 after the deep sleep state 914, continuing the communication cycle with the UE 920.

In some aspects, grouping multiple ROs consecutively, as shown in FIG. 9B, allows the UE 920 to enter a deep sleep state 914, significantly reducing power consumption compared to the legacy configuration shown in FIG. 9A. This approach provides the UE 920 with the benefit of extended periods of inactivity, during which it can conserve energy by entering deeper sleep states. Additionally, or alternatively, the configuration may include varying intervals and grouping strategies based on network requirements and UE capabilities. For instance, the network entity 910 may dynamically adjust the grouping of consecutive ROs and the duration of deep sleep states based on real-time network conditions and UE activity levels, further optimizing power efficiency. Additionally, or alternatively, instead of grouping multiple ROs consecutively, the network entity 910 may stagger the ROs 912 at varying intervals, allowing the UE 920 to enter multiple shorter sleep states 914, optimizing power conservation based on the UE's activity pattern. For example, staggering the ROs may provide a balance between communication needs and power savings by allowing the UE to adapt its sleep schedule dynamically. Additionally, or alternatively, the network entity 910 may prioritize certain types of ROs 912 based on their importance, ensuring critical communications are transmitted first, and allowing the UE 920 to enter a deep sleep state 914 sooner, thereby conserving more power. For instance, prioritizing emergency or high-priority signals can ensure timely processing while maximizing energy efficiency.

As indicated above, FIGS. 9A-9B are provided as examples. Other examples may differ from what is described with regard to FIGS. 9A-9B.

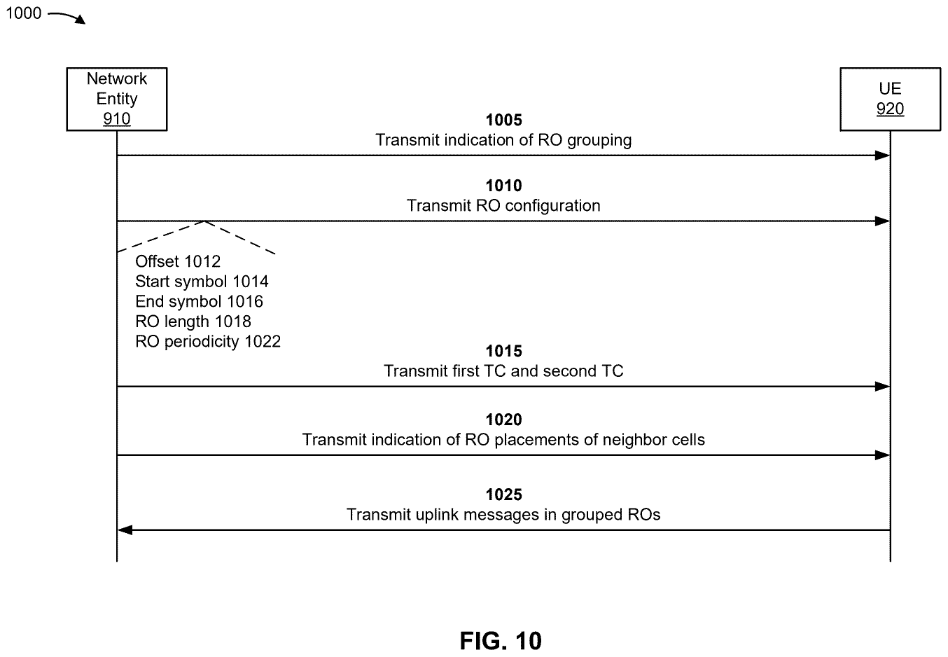

FIG. 10 is a diagram illustrating an example 1000 of using grouped ROs.

As shown by FIG. 10, and example 1000, the network entity 910 may provide an indication of RO grouping, as indicated by 1005. This indication allows the UE 920 to understand that multiple ROs are grouped consecutively, optimizing the timing for uplink message transmissions. In some aspects, the indication of RO grouping may include the provision of multiple TCs for different signals such as a DRS and a full SSB or PBCH to limit power consumption by coordinating the wake-up times of the UE 920. For instance, the network entity 910 might specify the timing intervals for DRS and SSB, ensuring that the UE 920 only wakes up when necessary. Additionally, or alternatively, the indication of RO grouping may include an indication of a power offset between transmission powers for the first type of signal and the second type of signal, assisting the UE 920 in accurately combining measurements from both signals. This can help the UE 920 to better manage its power usage by understanding the power requirements for different signals. Additionally, or alternatively, the indication of RO grouping may include specification on whether the UE 920 can use DRS-based measurements for cell reselection and whether these measurements can be combined with full SSB measurements, providing clear guidelines for the UE 920.

The network entity 910 may also provide an RO configuration, as indicated by 1010. This RO configuration may include an offset 1012, a start symbol 1014, an end symbol 1016, an RO length 1018, and an RO periodicity 1022. These parameters define the specific details of the ROs, enabling the UE 920 to align its transmissions accurately. In some aspects, the RO configuration 1010 may include information about the beam patterns of neighboring cells, including the number of beams or a mapping between beams for different signals, to improve the accuracy of the UE's measurements and cell reselection process. For example, the network entity 910 may provide data on the beam patterns used by neighboring cells, enabling the UE 920 to select the optimal beam for communication. Additionally, or alternatively, the RO configuration 1010 may include an indication of rough timing of RACH occasions for neighboring cells within the SIB, allowing the UE 920 to prepare its transmission hardware in advance and reduce the overall latency for random access procedures.

As further shown, the network entity 910 may provide a first TC for a first type of signal and a second TC for a second type of signal, as indicated by 1015. This coordination of TCs helps the UE 920 to manage its wake-up schedule more efficiently, reducing power consumption. In some aspects, the first TC and second TC 1015 may include timing configurations for a DRS and a full SSB or PBCH, ensuring that the UE 920 only wakes up for the more critical signal when both signals are scheduled to overlap. For example, the network entity 910 might prioritize DRS over SSB when both are scheduled simultaneously. Additionally, or alternatively, the first TC and second TC 1015 may include the provision of information about the timing configurations for different signals, such as the start and end times for DRS and SSB, enabling the UE 920 to optimize its wake-up schedule.

Additionally, the network entity 910 may provide an indication of RO placements of neighbor cells, as indicated by 1020. This information assists the UE 920 in planning its communication strategy and optimizing its uplink message transmissions during the grouped ROs. In some aspects, the indication of RO placements 1020 may include details on the timing configurations of neighboring cells, such as the start and end times for RACH occasions, enabling the UE 920 to align its transmissions with the RACH occasions of neighboring cells. For instance, the network entity 910 may provide timing estimates for RACH occasions within the SIB. Additionally, or alternatively, the indication of RO placements 1020 may include information on the beam patterns used by neighboring cells, assisting the UE 920 in selecting the optimal beam for communication.

Finally, the UE 920 may transmit uplink messages in the grouped ROs, as indicated by 1025. This transmission strategy ensures that the UE 920 utilizes the grouped ROs effectively, improving communication efficiency and reducing latency. In some aspects, the transmission of uplink messages 1025 may include the UE 920 using the provided timing configurations to schedule its uplink transmissions during the grouped ROs, ensuring efficient use of available resources. Additionally, or alternatively, the transmission of uplink messages 1025 may include the UE 920 optimizing its transmission power based on the power offset provided by the network entity 910, ensuring effective communication with minimal power consumption.

As indicated above, FIG. 10 is provided as an example. Other examples may differ from what is described with regard to FIG. 10.

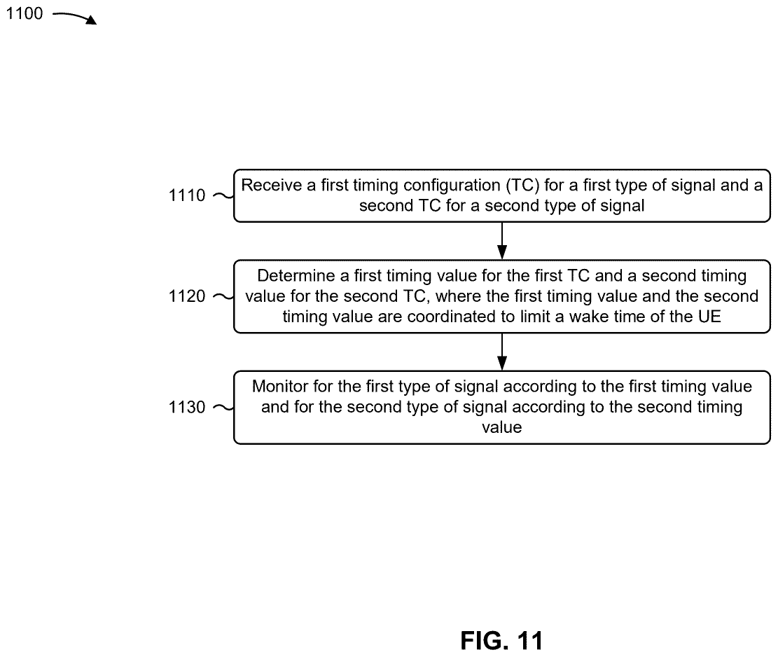

FIG. 11 is a diagram illustrating an example process 1100 performed, for example, at a UE or an apparatus of a UE. Example process 1100 is an example where the apparatus or the UE (e.g., UE 520) performs operations associated with coordinated TCs.

As shown in FIG. 11, in some aspects, process 1100 may include receiving a first TC for a first type of signal and a second TC for a second type of signal (block 1110). For example, the UE (e.g., using communication manager 150 or reception component 1502, depicted in FIG. 15) may receive a first TC for a first type of signal and a second TC for a second type of signal, as described above.

As further shown in FIG. 11, in some aspects, process 1100 may include determining a first timing value for the first TC and a second timing value for the second TC, where the first timing value and the second timing value are coordinated to limit (or in association with limiting) a wake time of the UE (block 1120). For example, the UE (e.g., using communication manager 150 or timing component 1508, depicted in FIG. 15) may determine a first timing value for the first TC and a second timing value for the second TC, where the first timing value and the second timing value are coordinated to limit a wake time of the UE, as described above.

As further shown in FIG. 11, in some aspects, process 1100 may include monitoring for the first type of signal according to the first timing value and for the second type of signal according to the second timing value (block 1130). For example, the ue (e.g., using communication manager 150 or measurement component 1510, depicted in FIG. 15) may monitor for the first type of signal according to the first timing value and for the second type of signal according to the second timing value, as described above.

Process 1100 may include additional aspects, such as any single aspect or any combination of aspects described below or in connection with one or more other processes described elsewhere herein.

In a first aspect, the first type of signal is a DRS and the second type of signal is one of an SSB, a PBCH message, or a SIB.

In a second aspect, alone or in combination with the first aspect, the first timing value and the second timing value overlap, and process 1100 includes prioritizing reception of the first type of signal or the second type of signal based at least in part on a comparison of a priority of the first type of signal and a priority of the second type of signal.

In a third aspect, alone or in combination with one or more of the first and second aspects, the timing value of the first type of signal is greater than 5 subframes.

In a fourth aspect, alone or in combination with one or more of the first through third aspects, process 1100 includes adjusting a wake-up schedule of the UE based at least in part on coordination of the first type of signal and the second type of signal to limit power consumption during periods of inactivity.

In a fifth aspect, alone or in combination with one or more of the first through fourth aspects, process 1100 includes determining whether one or more DRS-based measurements are permissible for a UE to use for cell reselection based at least in part on an indication received with one or more of the first TC or the second TC.

In a sixth aspect, alone or in combination with one or more of the first through fifth aspects, process 1100 includes determining whether one or more measurements for the first type of signal are combinable with one or more measurements for the second type of signal based at least in part on an indication received with one or more of the first TC or the second TC.

In a seventh aspect, alone or in combination with one or more of the first through sixth aspects, process 1100 includes receiving an indication of a power offset between a transmission power for the first type of signal and a transmission power for the second type of signal.

In an eighth aspect, alone or in combination with one or more of the first through seventh aspects, process 1100 includes decoding a one-to-one mapping between one or more cell IDs and one or more signal IDs based at least in part on an indication received with one or more of the first TC or the second TC.

In a ninth aspect, alone or in combination with one or more of the first through eighth aspects, process 1100 includes receiving an indication of a first beam pattern for the first TC and a second beam pattern for the second TC, and adjusting a measurement procedure based at least in part on the first beam pattern and the second beam pattern.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network entity or an apparatus of a network entity. Example process 1200 is an example where the apparatus or the network entity (e.g., network entity 510) performs operations associated with coordinated TCs.

As shown in FIG. 12, in some aspects, process 1200 may include providing a first TC for a first type of signal and a second TC for a second type of signal, where a first timing value for the first TC and a second timing value for the second TC are coordinated in association with limiting a wake time of a user equipment (block 1210). For example, the network entity (e.g., using communication manager 155 or transmission component 1804, depicted in FIG. 18) may provide a first TC for a first type of signal and a second TC for a second type of signal, where a first timing value for the first TC and a second timing value for the second TC are coordinated in association with limiting a wake time of a user equipment, as described above.

As further shown in FIG. 12, in some aspects, process 1200 may include providing the first type of signal according to the first timing value and the second type of signal according to the second timing value (block 1220). For example, the network entity (e.g., using communication manager 155 or transmission component 1804, depicted in FIG. 18) may provide the first type of signal according to the first timing value and the second type of signal according to the second timing value, as described above.

Process 1200 may include additional aspects, such as any single aspect or any combination of aspects described below or in connection with one or more other processes described elsewhere herein.

In a first aspect, process 1200 includes determining the first TC and the second TC.

In a second aspect, alone or in combination with the first aspect, the first type of signal is a DRS and the second type of signal is one or more of an SSB, a PBCH message, or a SIB.

In a third aspect, alone or in combination with one or more of the first and second aspects, process 1200 includes transmitting an indication of a power offset between a transmission power for the first type of signal and a transmission power for the second type of signal.

In a fourth aspect, alone or in combination with one or more of the first through third aspects, process 1200 includes transmitting an indication of a first beam pattern for the first TC and a second beam pattern for the second TC.

In a fifth aspect, alone or in combination with one or more of the first through fourth aspects, process 1200 includes determining the first TC and the second TC.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a UE or an apparatus of a UE. Example process 1300 is an example where the apparatus or the UE (e.g., UE 920) performs operations associated with grouping ROs.

As shown in FIG. 13, in some aspects, process 1300 may include receiving an indication that multiple ROs are to be grouped consecutively (block 1310). For example, the UE (e.g., using communication manager 150 or reception component 1502, depicted in FIG. 15) may receive an indication that multiple ROs are to be grouped consecutively, as described above.

As further shown in FIG. 13, in some aspects, process 1300 may include transmitting one or more uplink messages in multiple consecutive ROs (block 1320). For example, the UE (e.g., using communication manager 150 or transmission component 1504, depicted in FIG. 15) may transmit one or more uplink messages in multiple consecutive ROs, as described above.

Process 1300 may include additional aspects, such as any single aspect or any combination of aspects described below or in connection with one or more other processes described elsewhere herein.

In a first aspect, process 1300 includes receiving a first TC for a first type of signal to be received in a group of the multiple consecutive ROs and a second TC for a second type of signal to be received in the group of the multiple consecutive ROs.

In a second aspect, alone or in combination with the first aspect, process 1300 includes receiving an RO configuration that indicates an offset, a start symbol, an end symbol, a length of an RO, a periodicity of ROs, or a combination thereof.

In a third aspect, alone or in combination with one or more of the first and second aspects, process 1300 includes receiving an indication of one or more RO placements of neighbor cells in association with reselection.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network entity or an apparatus of a network entity. Example process 1400 is an example where the apparatus or the network entity (e.g., network entity 910) performs operations associated with grouping ROs.

As shown in FIG. 14, in some aspects, process 1400 may include providing an indication that multiple ROs are to be grouped consecutively (block 1410). For example, the network entity (e.g., using communication manager 155 or RO component 1810, depicted in FIG. 18) may provide an indication that multiple ROs are to be grouped consecutively, as described above.

As further shown in FIG. 14, in some aspects, process 1400 may include receiving uplink messages in the multiple ROs (block 1420). For example, the network entity (e.g., using communication manager 155 or reception component 1802, depicted in FIG. 18) may receive uplink messages in the multiple ROs, as described above.

Process 1400 may include additional aspects, such as any single aspect or any combination of aspects described below or in connection with one or more other processes described elsewhere herein.

In a first aspect, process 1400 includes providing a first TC for a first type of signal to be received in a group of the multiple ROs and a second TC for a second type of signal to be received in the group.

In a second aspect, alone or in combination with the first aspect, process 1400 includes providing an RO configuration that indicates an offset, a start symbol, an end symbol, a length of an RO, a periodicity of ROs, or a combination thereof.

In a third aspect, alone or in combination with one or more of the first and second aspects, process 1400 includes providing an indication of one or more RO placements of neighbor cells in association with reselection.

In a fourth aspect, alone or in combination with one or more of the first through third aspects, process 1400 includes providing the indication in other system information (OSI).

In a fifth aspect, alone or in combination with one or more of the first through fourth aspects, the OSI indicates RO placements or a timing estimate of one or more ROs.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a UE, or a UE may include the apparatus 1500. In some aspects, the apparatus 1500 includes a reception component 1502 and a transmission component 1504, which may be in communication with one another (for example, via one or more buses or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include one or more of a timing component 1508 or a measurement component 1510, among other examples. The communication manager 150 may be included in, or implemented via, a processing system (for example, the processing system 140 described in connection with FIG. 1) of the UE.

In some aspects, the apparatus 1500 may be configured to perform one or more operations described herein in connection with FIGS. 1-10. Additionally, or alternatively, the apparatus 1500 may be configured to perform one or more processes described herein, such as process 1100 of FIG. 11, process 1300 of FIG. 13, or a combination thereof. In some aspects, the apparatus 1500 or one or more components shown in FIG. 15 may include one or more components of the UE described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the UE described above in connection with FIG. 1, such as a radio, one or more RF chains, one or more transceivers, or one or more modems, each of which may in turn be coupled with one or more antennas of the UE.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1504 may be co-located with the reception component 1502.

In some aspects, the reception component 1502 may receive a first TC for a first type of signal and a second TC for a second type of signal. The timing component 1508 may determine a first timing value for the first TC and a second timing value for the second TC, where the first timing value and the second timing value are coordinated in association with limiting a wake time of the UE. The measurement component 1510 may monitor for the first type of signal according to the first timing value and for the second type of signal according to the second timing value.

The timing component 1508 may adjust a wake-up schedule of the UE based at least in part on coordination of the first type of signal and the second type of signal to limit power consumption during periods of inactivity. The measurement component 1510 may determine whether one or more discovery-reference-signal-based measurements are permissible for a UE to use for cell reselection based at least in part on an indication received with one or more of the first TC or the second TC. The measurement component 1510 may determine whether one or more measurements for the first type of signal are combinable with one or more measurements for the second type of signal based at least in part on an indication received with one or more of the first TC or the second TC.

The reception component 1502 may receive an indication of a power offset between a transmission power for the first type of signal and a transmission power for the second type of signal. The measurement component 1510 may decode a one-to-one mapping between one or more cell IDs and one or more signal IDs based at least in part on an indication received with one or more of the first TC or the second TC.

The reception component 1502 may receive an indication of a first beam pattern for the first TC and a second beam pattern for the second TC. The measurement component 1510 may adjust a measurement procedure based at least in part on the first beam pattern and the second beam pattern.

In some aspects, the reception component 1502 may receive an indication that multiple ROs are to be grouped consecutively. The transmission component 1504 may transmit one or more uplink messages in the multiple ROs. The reception component 1502 may receive a first TC for a first type of signal to be received in a group of the multiple consecutive ROs and a second TC for a second type of signal to be received in the group of the multiple consecutive ROs.

The reception component 1502 may receive an RO configuration that indicates an offset, a start symbol, an end symbol, a length of an RO, a periodicity of ROs, or a combination thereof. The reception component 1502 may receive an indication of one or more RO placements of neighbor cells in association with reselection.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

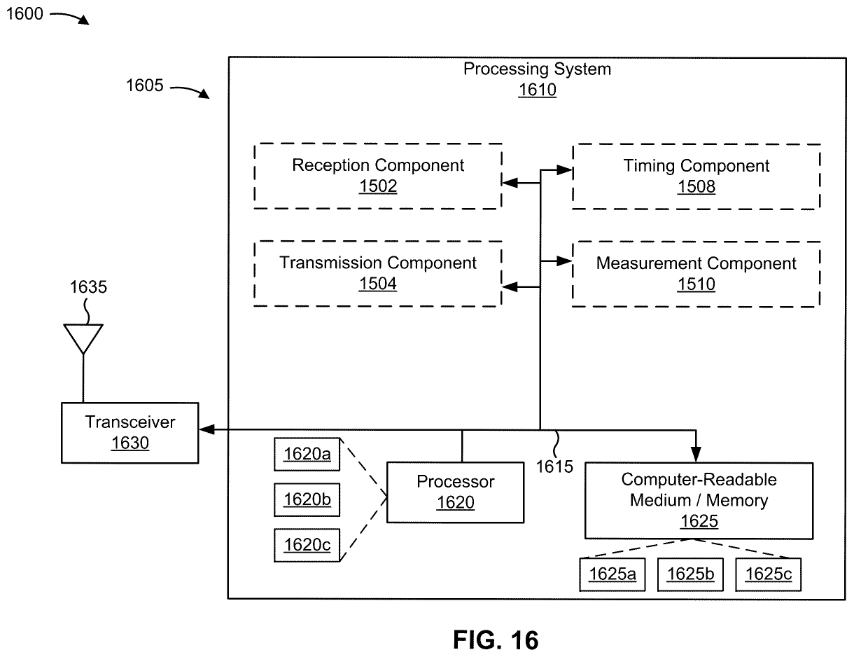

FIG. 16 is a diagram illustrating an example 1600 of a hardware implementation for an apparatus 1605 employing a processing system 1610. The apparatus 1605 may be a UE or may be at (e.g., included in) a UE. The processing system 1610 may be, or may be similar to, the processing system 140 of the UE 120 described in connection with FIG. 1.

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors or hardware components, represented by the processor (or processing circuitry) 1620, the illustrated components, and the computer-readable medium/memory (or memory circuitry) 1625. The processor 1620 may include multiple processors, such as processor 1620a, processor 1620b, and processor 1620c. The memory 1625 may include multiple memories, such as memory 1625a, memory 1625b, and memory 1625c The bus 1615 may also link various other circuits, such as timing sources, peripherals, voltage regulators, or power management circuits.

The processing system 1610 may be coupled to one or more transceivers 1630. A transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1502. In addition, the transceiver 1630 receives information from the processing system 1610, specifically the transmission component 1504, and generates a signal to be applied to the one or more antennas 1635 based at least in part on the received information.

The processing system 1610 includes one or more processors 1620 coupled to a computer-readable medium/memory 1625. A processor 1620 is responsible for general processing, including the execution of software stored on the computer-readable medium/memory 1625. The software, when executed by the processor 1620, causes the processing system 1610 to perform the various functions described herein for any particular apparatus. The computer-readable medium/memory 1625 may also be used for storing data that is manipulated by the processor 1620 when executing software. The processing system further includes at least one of the illustrated components. The components may be software modules running in the processor 1620, resident/stored in the computer readable medium/memory 1625, one or more hardware modules coupled to the processor 1620, or some combination thereof.

In some aspects, the processing system 1610 may be a component of the UE 120 or may be, may include, or may be included in the processing system 140 of the UE 120 described in connection with FIG. 1. In some aspects, the apparatus 1605 for wireless communication includes means for receiving a first TC for a first type of signal and a second TC for a second type of signal; means for determining a first timing value for the first TC and a second timing value for the second TC, where the first timing value and the second timing value are coordinated in association with limiting a wake time of the UE; and means for monitoring for the first type of signal according to the first timing value and for the second type of signal according to the second timing value. The aforementioned means for may be one or more of the aforementioned components of the apparatus 1500 or the processing system 1610 of the apparatus 1605 configured to perform the functions recited by the aforementioned means. As described elsewhere herein, the processing system 1610 may include one or more components of the processing system 140 of the UE 120 described in connection with FIG. 1. In one configuration, the aforementioned means may be the processing system 140 or one or more components of the processing system 140 configured to perform the functions or operations recited herein.

In some aspects, the processing system 1610 may be a component of the UE 120 or may be, may include, or may be included in the processing system 140 of the UE 120 described in connection with FIG. 1. In some aspects, the apparatus 1605 for wireless communication includes means for receiving an indication that multiple ROs are to be grouped consecutively; and means for transmitting one or more uplink messages in the multiple ROs. The aforementioned means may be one or more of the aforementioned components of the apparatus 1500 or the processing system 1610 of the apparatus 1605 configured to perform the functions recited by the aforementioned means. As described elsewhere herein, the processing system 1610 may include one or more components of the processing system 140 of the UE 120 described in connection with FIG. 1. In one configuration, the aforementioned means may be the processing system 140 or one or more components of the processing system 140 configured to perform the functions or operations recited herein.

FIG. 16 is provided as an example. Other examples may differ from what is described in connection with FIG. 16.

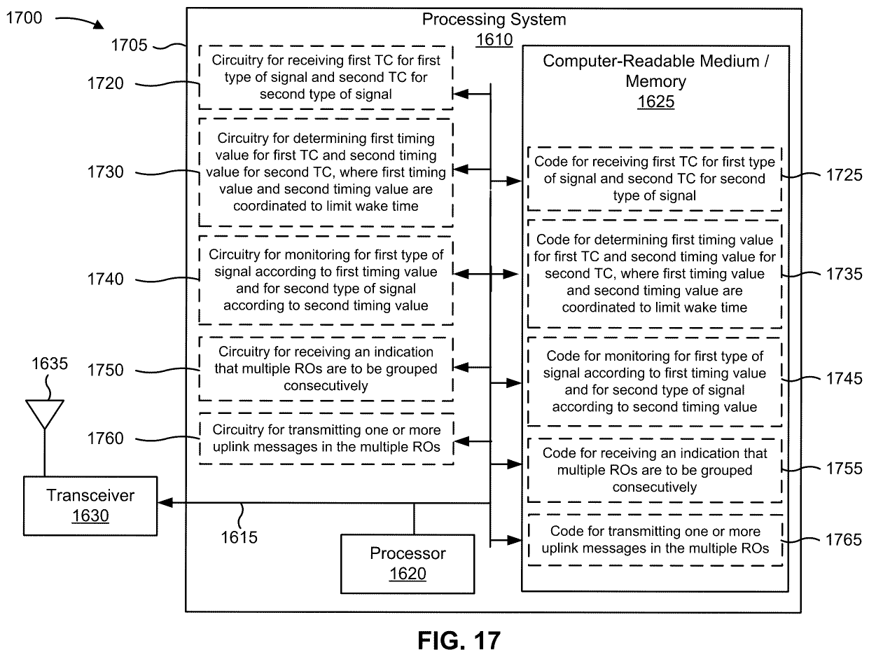

FIG. 17 is a diagram illustrating an example 1700 of an implementation of code and circuitry for an apparatus 1705. The apparatus 1705 may be a UE, or a UE may include the apparatus 1705.

As shown in FIG. 17, the apparatus 1705 may include circuitry for receiving a first TC for a first type of signal and a second TC for a second type of signal (circuitry 1720). For example, the circuitry 1720 may enable the apparatus 1705 to receive a first TC for a first type of signal and a second TC for a second type of signal.

As shown in FIG. 17, the apparatus 1705 may include, stored in computer-readable medium 1625, code for receiving a first TC for a first type of signal and a second TC for a second type of signal (code 1725). For example, the code 1725, when executed by processor 1620, may cause processor 1620 to cause transceiver 1630 to receive a first TC for a first type of signal and a second TC for a second type of signal.

As shown in FIG. 17, the apparatus 1705 may include circuitry for determining a first timing value for the first TC and a second timing value for the second TC, where the first timing value and the second timing value are coordinated in association with limiting a wake time of the UE (circuitry 1730). For example, the circuitry 1730 may enable the apparatus 1705 to determine a first timing value for the first TC and a second timing value for the second TC, where the first timing value and the second timing value are coordinated in association with limiting a wake time of the UE.

As shown in FIG. 17, the apparatus 1705 may include, stored in computer-readable medium 1625, code for determining a first timing value for the first TC and a second timing value for the second TC, where the first timing value and the second timing value are coordinated in association with limiting a wake time of the UE (code 1735). For example, the code 1735, when executed by processor 1620, may cause processor 1620 to determine a first timing value for the first TC and a second timing value for the second TC, where the first timing value and the second timing value are coordinated in association with limiting a wake time of the UE.

As shown in FIG. 17, the apparatus 1705 may include circuitry for monitoring for the first type of signal according to the first timing value and for the second type of signal according to the second timing value (circuitry 1740). For example, the circuitry 1740 may enable the apparatus 1705 to monitor for the first type of signal according to the first timing value and for the second type of signal according to the second timing value.

As shown in FIG. 17, the apparatus 1705 may include, stored in computer-readable medium 1625, code for monitoring for the first type of signal according to the first timing value and for the second type of signal according to the second timing value (code 1745). For example, the code 1745, when executed by processor 1620, may cause processor 1620 to cause transceiver 1630 to monitor for the first type of signal according to the first timing value and for the second type of signal according to the second timing value.

As shown in FIG. 17, the apparatus 1705 may include circuitry for receiving an indication that multiple ROs are to be grouped consecutively (circuitry 1750). For example, the circuitry 1750 may enable the apparatus 1705 to receive an indication that multiple ROs are to be grouped consecutively.

As shown in FIG. 17, the apparatus 1705 may include, stored in computer-readable medium 1625, code for receiving an indication that multiple ROs are to be grouped consecutively (code 1755). For example, the code 1755, when executed by processor 1620, may cause processor 1620 to cause transceiver 1630 to receive an indication that multiple ROs are to be grouped consecutively.

As shown in FIG. 17, the apparatus 1705 may include circuitry for transmitting one or more uplink messages in the multiple ROs (circuitry 1760). For example, the circuitry 1760 may enable the apparatus 1705 to transmit one or more uplink messages in the multiple ROs.

As shown in FIG. 17, the apparatus 1705 may include, stored in computer-readable medium 1625, code for transmitting one or more uplink messages in the multiple ROs (code 1765). For example, the code 1765, when executed by processor 1620, may cause processor 1620 to cause transceiver 1630 to transmit one or more uplink messages in the multiple ROs.

FIG. 17 is provided as an example. Other examples may differ from what is described in connection with FIG. 17.

FIG. 18 is a diagram of an example apparatus 1800 for wireless communication. The apparatus 1800 may be a network entity, or a network entity may include the apparatus 1800. In some aspects, the apparatus 1800 includes a reception component 1802 and a transmission component 1804, which may be in communication with one another (for example, via one or more buses or one or more other components). As shown, the apparatus 1800 may communicate with another apparatus 1806 (such as a UE, a base station, or another wireless communication device) using the reception component 1802 and the transmission component 1804. As further shown, the apparatus 1800 may include the communication manager 155. The communication manager 155 may include one or more of a timing component 1808 or an RO component 1810, among other examples. The communication manager 155 may be included in, or implemented via, a processing system (for example, the processing system 145 described in connection with FIG. 1) of the network entity.

In some aspects, the apparatus 1800 may be configured to perform one or more operations described herein in connection with FIGS. 1-10. Additionally, or alternatively, the apparatus 1800 may be configured to perform one or more processes described herein, such as process 1200 of FIG. 12, process 1400 of FIG. 14, or a combination thereof. In some aspects, the apparatus 1800 or one or more components shown in FIG. 18 may include one or more components of the network entity described in connection with FIG. 1. Additionally, or alternatively, one or more components shown in FIG. 18 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications, and may provide the processed signals to the one or more other components of the apparatus 1800. In some aspects, the reception component 1802 may include one or more components of the network entity described above in connection with FIG. 1, such as a radio, one or more RF chains, one or more transceivers, or one or more modems, each of which may in turn be coupled with one or more antennas of the network entity.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more components of the network entity described above in connection with FIG. 1, such as a radio, one or more RF chains, one or more transceivers, or one or more modems, each of which may in turn be coupled with one or more antennas of the network entity described in connection with FIG. 1. In some aspects, the transmission component 1804 may be co-located with the reception component 1802.

In some aspects, the timing component 1808 may provide a first TC for a first type of signal and a second TC for a second type of signal, where a first timing value for the first TC and a second timing value for the second TC are coordinated in association with limiting a wake time of a user equipment. The transmission component 1804 may provide (e.g., transmit) the first type of signal according to the first timing value and the second type of signal according to the second timing value. The timing component 1808 may determine the first TC and the second TC.

The transmission component 1804 may transmit an indication of a power offset between a transmission power for the first type of signal and a transmission power for the second type of signal. The transmission component 1804 may transmit an indication of a first beam pattern for the first TC and a second beam pattern for the second TC.

In some aspects, the RO component 1810 may provide an indication that multiple ROs are to be grouped consecutively. The reception component 1802 may receive uplink messages in the multiple ROs.

The timing component 1808 may provide a first TC for a first type of signal to be received in a group of the multiple ROs and a second TC for a second type of signal to be received in the group. The RO component 1810 may provide an RO configuration that indicates an offset, a start symbol, an end symbol, a length of an RO, a periodicity of ROs, or a combination thereof.

The RO component 1810 may provide an indication of one or more RO placements of neighbor cells in association with reselection. The RO component 1810 may provide the indication in other system information (OSI).

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

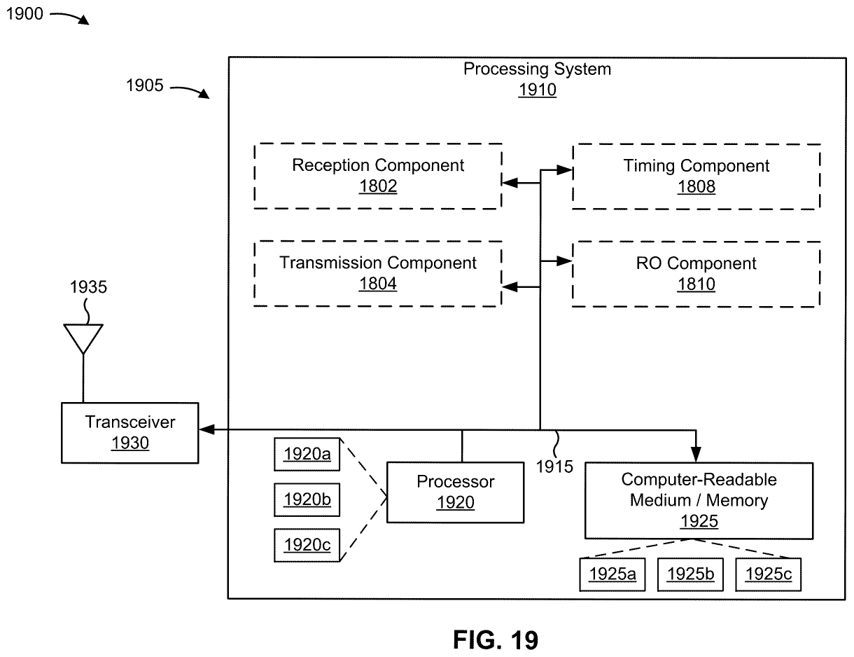

FIG. 19 is a diagram illustrating an example 1900 of a hardware implementation for an apparatus 1905 employing a processing system 1910. The apparatus 1905 may be a network entity or may be at (e.g., included in) a network entity. The processing system 1910 may be, or may be similar to, the processing system 145 described in connection with FIG. 1.

The processing system 1910 may be implemented with a bus architecture, represented generally by the bus 1915. The bus 1915 may include any number of interconnecting buses and bridges depending on the specific application of the processing system 1910 and the overall design constraints. The bus 1915 links together various circuits including one or more processors or hardware components, represented by the processor (or processing circuitry) 1920, the illustrated components, and the computer-readable medium/memory (or memory circuitry) 1925. The processor 1920 may include multiple processors, such as processor 1920a, processor 1920b, and processor 1920c. The memory 1925 may include multiple memories, such as memory 1925a, memory 1925b, and memory 1925c The bus 1915 may also link various other circuits, such as timing sources, peripherals, voltage regulators, or power management circuits.

The processing system 1910 may be coupled to one or more transceivers 1930. A transceiver 1930 is coupled to one or more antennas 1935. The transceiver 1930 provides a means for communicating with various other apparatuses over a transmission medium. The transceiver 1930 receives a signal from the one or more antennas 1935, extracts information from the received signal, and provides the extracted information to the processing system 1910, specifically the reception component 1802. In addition, the transceiver 1930 receives information from the processing system 1910, specifically the transmission component 1804, and generates a signal to be applied to the one or more antennas 1935 based at least in part on the received information.

The processing system 1910 includes one or more processors 1920 coupled to a computer-readable medium/memory 1925. A processor 1920 is responsible for general processing, including the execution of software stored on the computer-readable medium/memory 1925. The software, when executed by the processor 1920, causes the processing system 1910 to perform the various functions described herein for any particular apparatus. The computer-readable medium/memory 1925 may also be used for storing data that is manipulated by the processor 1920 when executing software. The processing system further includes at least one of the illustrated components. The components may be software modules running in the processor 1920, resident/stored in the computer readable medium/memory 1925, one or more hardware modules coupled to the processor 1920, or some combination thereof.

In some aspects, the processing system 1910 may be a component of the network node 110 or may be, may include, or may be included in the processing system 145 of the network node 110 described in connection with FIG. 1. In some aspects, the apparatus 1905 for wireless communication includes means for providing a first TC for a first type of signal and a second TC for a second type of signal, where a first timing value for the first TC and a second timing value for the second TC are coordinated in association with limiting a wake time of a user equipment; and means for providing the first type of signal according to the first timing value and the second type of signal according to the second timing value. The aforementioned means may be one or more of the aforementioned components of the apparatus 1800 or the processing system 1910 of the apparatus 1905 configured to perform the functions recited by the aforementioned means. As described elsewhere herein, the processing system 1910 may include one or more components of the processing system 145. In one configuration, the aforementioned means may be processing system 145 or one or more components of the processing system 145 configured to perform the functions or operations recited herein.

In some aspects, the processing system 1910 may be a component of the network node 110 or may be, may include, or may be included in the processing system 145 of the network node 110 described in connection with FIG. 1. In some aspects, the apparatus 1905 for wireless communication includes means for providing an indication that multiple ROs are to be grouped consecutively; and means for receiving uplink messages in the multiple ROs. The aforementioned means may be one or more of the aforementioned components of the apparatus 1800 or the processing system 1910 of the apparatus 1905 configured to perform the functions recited by the aforementioned means. As described elsewhere herein, the processing system 1910 may include one or more components of the processing system 145. In one configuration, the aforementioned means may be processing system 145 or one or more components of the processing system 145 configured to perform the functions or operations recited herein.

FIG. 19 is provided as an example. Other examples may differ from what is described in connection with FIG. 19.

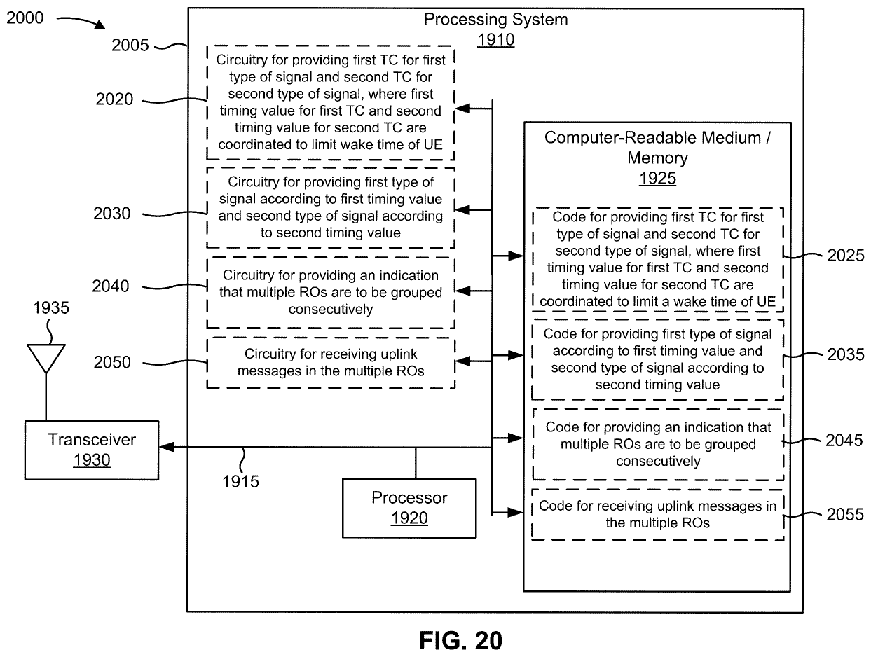

FIG. 20 is a diagram illustrating an example 2000 of an implementation of code and circuitry for an apparatus 2005. The apparatus 2005 may be a network entity, or a network entity may include the apparatus 2005.

As shown in FIG. 20, the apparatus 2005 may include circuitry for providing a first TC for a first type of signal and a second TC for a second type of signal, wherein a first timing value for the first TC and a second timing value for the second TC are coordinated in association with limiting a wake time of a user equipment (circuitry 2020). For example, the circuitry 2020 may enable the apparatus 2005 to provide a first TC for a first type of signal and a second TC for a second type of signal, wherein a first timing value for the first TC and a second timing value for the second TC are coordinated in association with limiting a wake time of a user equipment.

As shown in FIG. 20, the apparatus 2005 may include, stored in computer-readable medium 1925, code for providing a first TC for a first type of signal and a second TC for a second type of signal, wherein a first timing value for the first TC and a second timing value for the second TC are coordinated in association with limiting a wake time of a user equipment (code 2025). For example, the code 2025, when executed by processor 1920, may cause processor 1920 to cause transceiver 1930 to provide a first TC for a first type of signal and a second TC for a second type of signal, wherein a first timing value for the first TC and a second timing value for the second TC are coordinated to limit a wake time of a user equipment.

As shown in FIG. 20, the apparatus 2005 may include circuitry for providing the first type of signal according to the first timing value and the second type of signal according to the second timing value (circuitry 2030). For example, the circuitry 2030 may enable the apparatus 2005 to provide the first type of signal according to the first timing value and the second type of signal according to the second timing value.

As shown in FIG. 20, the apparatus 2005 may include, stored in computer-readable medium 1925, code for providing the first type of signal according to the first timing value and the second type of signal according to the second timing value (code 2035). For example, the code 2035, when executed by processor 1920, may cause processor 1920 to cause transceiver 1930 to provide the first type of signal according to the first timing value and the second type of signal according to the second timing value.

As shown in FIG. 20, the apparatus 2005 may include circuitry for providing an indication that multiple ROs are to be grouped consecutively (circuitry 2040). For example, the circuitry 2040 may enable the apparatus 2005 to provide an indication that multiple ROs are to be grouped consecutively.

As shown in FIG. 20, the apparatus 2005 may include, stored in computer-readable medium 1925, code for providing an indication that multiple ROs are to be grouped consecutively (code 2045). For example, the code 2045, when executed by processor 1920, may cause processor 1920 to cause transceiver 1930 to provide an indication that multiple ROs are to be grouped consecutively.

As shown in FIG. 20, the apparatus 2005 may include circuitry for receiving uplink messages in the multiple ROs (circuitry 2050). For example, the circuitry 2050 may enable the apparatus 2005 to receive uplink messages in the multiple ROs.

As shown in FIG. 20, the apparatus 2005 may include, stored in computer-readable medium 1925, code for receiving uplink messages in the multiple ROs (code 2055). For example, the code 2055, when executed by processor 1920, may cause processor 1920 to cause transceiver 1930 to receive uplink messages in the multiple ROs.

FIG. 20 is provided as an example. Other examples may differ from what is described in connection with FIG. 20.

The following provides an overview of some Aspects of the present disclosure:
Aspect 1: A method of wireless communication at a user equipment (UE), comprising: receiving a first timing configuration (TC) for a first type of signal and a second TC for a second type of signal; determining a first timing value for the first TC and a second timing value for the second TC, wherein the first timing value and the second timing value are coordinated to limit a wake time of the UE; and monitoring for the first type of signal according to the first timing value and for the second type of signal according to the second timing value.
Aspect 2: The method of Aspect 1, wherein the first type of signal is a discovery reference signal and the second type of signal is one of a synchronization signal block, a physical broadcast channel, or a system information block.
Aspect 3: The method of any of Aspects 1-2, wherein the first timing value and the second timing value overlap, and wherein the method further comprises prioritizing reception of the first type of signal or the second type of signal based at least in part on a comparison of a priority of the first type of signal and a priority of the second type of signal.
Aspect 4: The method of any of Aspects 1-3, wherein the timing value of the first type of signal is greater than 5 subframes.
Aspect 5: The method of any of Aspects 1-4, further comprising: adjusting a wake-up schedule of the UE based at least in part on coordination of the first type of signal and the second type of signal in association with limiting power consumption during periods of inactivity.
Aspect 6: The method of any of Aspects 1-5, further comprising: determining whether one or more discovery-reference-signal-based measurements are permissible for a UE to use for cell reselection based at least in part on an indication received with one or more of the first TC or the second TC.
Aspect 7: The method of any of Aspects 1-6, further comprising: determining whether one or more measurements for the first type of signal are combinable with one or more measurements for the second type of signal based at least in part on an indication received with one or more of the first TC or the second TC.
Aspect 8: The method of any of Aspects 1-7, further comprising: receiving an indication of a power offset between a transmission power for the first type of signal and a transmission power for the second type of signal.
Aspect 9: The method of any of Aspects 1-8, further comprising: decoding a one-to-one mapping between one or more cell identifiers (IDs) and one or more signal IDs based at least in part on an indication received with one or more of the first TC or the second TC.
Aspect 10: The method of any of Aspects 1-9, further comprising: receiving an indication of a first beam pattern for the first TC and a second beam pattern for the second TC; and adjusting a measurement procedure based at least in part on the first beam pattern and the second beam pattern.
Aspect 11: A method of wireless communication at a network entity, comprising: providing a first timing configuration (TC) for a first type of signal and a second TC for a second type of signal, wherein a first timing value for the first TC and a second timing value for the second TC are coordinated to limit a wake time of a user equipment; and providing the first type of signal according to the first timing value and the second type of signal according to the second timing value.
Aspect 12: The method of Aspect 11, further comprising: determining the first TC and the second TC.
Aspect 13: The method of any of Aspects 11-12, wherein the first type of signal is a discovery reference signal and the second type of signal is one or more of a synchronization signal block, a physical broadcast channel, or a system information block.
Aspect 14: The method of any of Aspects 11-13, further comprising: transmitting an indication of a power offset between a transmission power for the first type of signal and a transmission power for the second type of signal.
Aspect 15: The method of any of Aspects 11-14, further comprising: transmitting an indication of a first beam pattern for the first TC and a second beam pattern for the second TC.
Aspect 16: A method of wireless communication at a user equipment (UE), comprising: receiving an indication that multiple random access channel occasions (ROs) are to be grouped consecutively; and transmitting one or more uplink messages in multiple consecutive ROs.
Aspect 17: The method of Aspect 16, further comprising: receiving a first timing configuration (TC) for a first type of signal to be received in a group of the multiple consecutive ROs and a second TC for a second type of signal to be received in the group of the multiple consecutive ROs.
Aspect 18: The method of any of Aspects 16-17, further comprising receiving an RO configuration that indicates an offset, a start symbol, an end symbol, a length of an RO, a periodicity of ROs, or a combination thereof.
Aspect 19: The method of any of Aspects 16-18, further comprising receiving an indication of one or more RO placements of neighbor cells in association with reselection.
Aspect 20: A method of wireless communication at a network entity, comprising: providing an indication that multiple random access channel occasions (ROs) are to be grouped consecutively; and receiving uplink messages in multiple consecutive ROs.
Aspect 21: The method of Aspect 20, further comprising providing a first timing configuration (TC) for a first type of signal to be received in a group of the multiple ROs and a second TC for a second type of signal to be received in the group.
Aspect 22: The method of any of Aspects 20-21, further comprising providing an RO configuration that indicates an offset, a start symbol, an end symbol, a length of an RO, a periodicity of ROs, or a combination thereof.
Aspect 23: The method of any of Aspects 20-22, further comprising providing an indication of one or more RO placements of neighbor cells in association with reselection.
Aspect 24: The method of Aspect 23, further comprising providing the indication in other system information (OSI).
Aspect 25: The method of Aspect 24, wherein the OSI indicates RO placements or a timing estimate of one or more ROs.
Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.
Aspect 27: An apparatus for wireless communication at a device, the apparatus comprising one or more memories and one or more processors coupled to the one or more memories, the one or more processors configured to cause the device to perform the method of one or more of Aspects 1-25.
Aspect 28: An apparatus for wireless communication, the apparatus comprising at least one means for performing the method of one or more of Aspects 1-25.
Aspect 29: A non-transitory computer-readable medium storing code for wireless communication, the code comprising instructions executable by one or more processors to perform the method of one or more of Aspects 1-25.
Aspect 30: A non-transitory computer-readable medium storing a set of instructions for wireless communication, the set of instructions comprising one or more instructions that, when executed by one or more processors of a device, cause the device to perform the method of one or more of Aspects 1-25.
Aspect 31: A device for wireless communication, the device comprising a processing system that includes one or more processors and one or more memories coupled with the one or more processors, the processing system configured to cause the device to perform the method of one or more of Aspects 1-25.
Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.
Aspect 33: A device comprising a processing system that includes one or more processors and one or more code-storing memories coupled with the one or more processors, the processing system configured to cause the device to perform the method of one or more of Aspects 1-25.
Aspect 34: A device comprising a processing system that includes processor circuitry and code-storing memory circuitry, the processing system configured to cause the device to perform the method of one or more of Aspects 1-25.
Aspect 35: An apparatus for wireless communication at a user equipment (UE), comprising: one or more memories; and one or more processors coupled to the one or more memories, the one or more processors configured to cause the UE to: receive a first timing configuration (TC) for a first type of signal and a second TC for a second type of signal; determine a first timing value for the first TC and a second timing value for the second TC, wherein the first timing value and the second timing value are coordinated to limit a wake time of the UE; and monitor for the first type of signal according to the first timing value and for the second type of signal according to the second timing value.
Aspect 36: The apparatus of Aspect 35, wherein the one or more processors are configured, individually or collectively, to cause the UE to: receive a first timing configuration (TC) for a first type of signal and a second TC for a second type of signal; determine a first timing value for the first TC and a second timing value for the second TC, wherein the first timing value and the second timing value are coordinated to limit a wake time of the UE; and monitor for the first type of signal according to the first timing value and for the second type of signal according to the second timing value.
Aspect 37: An apparatus for wireless communication at a network entity, comprising: one or more memories; and one or more processors coupled to the one or more memories, the one or more processors configured to cause the network entity to: provide a first timing configuration (TC) for a first type of signal and a second TC for a second type of signal, wherein a first timing value for the first TC and a second timing value for the second TC are coordinated to limit a wake time of a user equipment; and provide the first type of signal according to the first timing value and the second type of signal according to the second timing value.
Aspect 38: The apparatus of Aspect 37, wherein the one or more processors are configured, individually or collectively, to cause the network entity to: provide a first timing configuration (TC) for a first type of signal and a second TC for a second type of signal, wherein a first timing value for the first TC and a second timing value for the second TC are coordinated to limit a wake time of a user equipment; and provide the first type of signal according to the first timing value and the second type of signal according to the second timing value.
Aspect 39: An apparatus for wireless communication at a user equipment (UE), comprising: one or more memories; and one or more processors coupled to the one or more memories, the one or more processors configured to cause UE to: receive an indication that multiple random access channel occasions (ROs) are to be grouped consecutively; and transmit one or more uplink messages in the multiple ROs.
Aspect 40: The apparatus of Aspect 39, wherein the one or more processors are configured, individually or collectively, to cause the UE to: receive an indication that multiple random access channel occasions (ROs) are to be grouped consecutively; and transmit one or more uplink messages in the multiple ROs.
Aspect 41: An apparatus for wireless communication at a network entity, comprising: one or more memories; and one or more processors coupled to the one or more memories, the one or more processors configured to cause the network entity to: provide an indication that multiple random access channel occasions (ROs) are to be grouped consecutively; and receive uplink messages in the multiple ROs.
Aspect 42: The apparatus of Aspect 41, wherein the one or more processors are configured, individually or collectively, to cause the network entity to: provide an indication that multiple random access channel occasions (ROs) are to be grouped consecutively; and receive uplink messages in the multiple ROs.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors coupled to the one or more memories and configured to cause the UE to:
receive a first timing configuration (TC) for a first type of signal and a second TC for a second type of signal;
determine a first timing value for the first TC and a second timing value for the second TC, wherein the first timing value and the second timing value are coordinated in association with limiting a wake time of the UE; and
monitor for the first type of signal according to the first timing value and for the second type of signal according to the second timing value.

2. The UE of claim 1, wherein the first type of signal is a discovery reference signal and the second type of signal is one of a synchronization signal block, a physical broadcast channel, or a system information block.

3. The UE of claim 1, wherein the first timing value and the second timing value overlap, and wherein the one or more processors are further configured to cause the UE to prioritize reception of the first type of signal or the second type of signal based at least in part on a comparison of a priority of the first type of signal and a priority of the second type of signal.

4. The UE of claim 1, wherein the timing value of the first type of signal is greater than 5 subframes.

5. The UE of claim 1, wherein the one or more processors are further configured to cause the UE to:
adjust a wake-up schedule of the UE based at least in part on coordination of the first type of signal and the second type of signal in association with limiting power consumption during periods of inactivity.

6. The UE of claim 1, wherein the one or more processors are further configured to cause the UE to:
determine whether one or more discovery-reference-signal-based measurements are permissible for a UE to use for cell reselection based at least in part on an indication received with one or more of the first TC or the second TC.

7. The UE of claim 1, wherein the one or more processors are further configured to cause the UE to:
determine whether one or more measurements for the first type of signal are combinable with one or more measurements for the second type of signal based at least in part on an indication received with one or more of the first TC or the second TC.

8. The UE of claim 1, wherein the one or more processors are further configured to cause the UE to:
receive an indication of a power offset between a transmission power for the first type of signal and a transmission power for the second type of signal.

9. The UE of claim 1, wherein the one or more processors are further configured to cause the UE to:
decode a one-to-one mapping between one or more cell identifiers (IDs) and one or more signal IDs based at least in part on an indication received with one or more of the first TC or the second TC.

10. The UE of claim 1, wherein the one or more processors are further configured to cause the UE to:
receive an indication of a first beam pattern for the first TC and a second beam pattern for the second TC; and
adjust a measurement procedure based at least in part on the first beam pattern and the second beam pattern.

11. A network entity for wireless communication, comprising:
one or more memories; and
one or more processors coupled to the one or more memories and configured to cause the network entity to:
provide a first timing configuration (TC) for a first type of signal and a second TC for a second type of signal, wherein a first timing value for the first TC and a second timing value for the second TC are coordinated in association with limiting a wake time of a user equipment; and
provide the first type of signal according to the first timing value and the second type of signal according to the second timing value.

12. The network entity of claim 11, wherein the one or more processors are further configured to cause the network entity to:
determine the first TC and the second TC.

13. The network entity of claim 11, wherein the first type of signal is a discovery reference signal and the second type of signal is one or more of a synchronization signal block, a physical broadcast channel, or a system information block.

14. The network entity of claim 11, wherein the one or more processors are further configured to cause the network entity to:
transmit an indication of a power offset between a transmission power for the first type of signal and a transmission power for the second type of signal.

15. The network entity of claim 11, wherein the one or more processors are further configured to cause the network entity to:
transmit an indication of a first beam pattern for the first TC and a second beam pattern for the second TC.

16. A user equipment (UE) for wireless communication, comprising:
one or more memories; and
one or more processors coupled to the one or more memories and configured to cause the UE to:
receive an indication that multiple random access channel occasions (ROs) are to be grouped consecutively; and
transmit one or more uplink messages in multiple consecutive ROs.

17. The UE of claim 16, wherein the one or more processors are further configured to cause the UE to:
receive a first timing configuration (TC) for a first type of signal to be received in a group of the multiple consecutive ROs and a second TC for a second type of signal to be received in the group of the multiple consecutive ROs.

18. The UE of claim 16, wherein the one or more processors are further configured to cause the UE to receive an RO configuration that indicates an offset, a start symbol, an end symbol, a length of an RO, a periodicity of ROs, or a combination thereof.

19. The UE of claim 16, wherein the one or more processors are further configured to cause the UE to receive an indication of one or more RO placements of neighbor cells in association with reselection.
